(19) United States
(12) Patent Application Publication
(10) Pub. No.: US 2008/0038478 A1
(43) Pub. Date: Feb. 14, 2008

(54) Thermal spray coating processes using HHO gas generated from an electrolyzer generator

(76) Inventor: Dennis J. Klein, Clearwater, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/502,040

(22) Filed: Aug. 10, 2006

(51) Int. Cl. B05D 1/08

(52) U.S. Cl. 427/446; 427/449

(57) ABSTRACT

A thermal spray coating process for depositing finely divided metallic or nonmetallic materials in a molten or semi-molten condition to form a coating on a substrate wherein the coating material may be powder, ceramic-rod, wire or molten materials. The process involves the use of a gas made from water in an electrolyzer, which includes two principal electrodes and a plurality of supplemental electrodes. The supplemental electrodes are not connected electrically to a power source. The electrolyzer is adapted to separate the water such that its constituents of H and O are not recombined and instead produced jointly to make the single combustible gas composed of combinations of clusters of hydrogen and oxygen atoms structured according to a general formula HₘOₙ wherein m and n have null or positive integer values with the exception that m and n can not be 0 at the same time.

### FIELD OF THE INVENTION

The invention relates to thermal spray coating processes using a novel HHO gas made from a water to gas electrolyzer generator.

### BACKGROUND OF THE INVENTION

A thermal spray coating is produced by a process in which molten or semi-molten particles are applied by impact onto a substrate.

A common feature of all thermal spray coatings is their “lenticular or lamellar” grain structure resulting from the rapid solidification of small globules, flattened from impacting a cold surface at high velocities.

Generally speaking there are six principal thermal spray methods. These are: combustion wire thermal spray process; combustion powder thermal spray process; arc wire thermal spray process; plasma thermal spray process; High Velocity Oxy-Fuel (HVOF) thermal spray process and detonation thermal spray process.

In each of these methods a material such as wire or powders are fed into a gun that rapidly melts them and propels them onto the part to be coated. The composition of these materials can vary widely and are custom blended to meet the end results required. However, generally their composition consists of pure metals, oxides, ceramics, nitrides, metal combinations and in some cases thermal plastics.

The materials being applied are melted in a variety of ways including “electrical arc,” combusted gases and arc with gas augmentation.

The following gives a brief explanation of each of the thermal spray methods or technologies, their limits and applications, and specific applications.

### Combustion Torch/Detonation Gun:

Flame spraying involves the use of a combustion flame spray torch in which a fuel gas and oxygen are fed through the torch and burned with the coating material in a powder or wire form and fed into the flame. The coating is heated to near or above its melting point and accelerated to speeds of 30 to 90 m/s. The molten droplets impinge on the surface where they flow together to form the coating.

This process is basically the spraying of molten material onto a surface to provide a coating. Material in powder form is melted in a flame (oxy-acetylene or hydrogen most common) to form a fine spray. When the spray contacts the prepared surface of a substrate material, the fine molten droplets rapidly solidify forming a coating. This process carried out correctly is called a “cold process” (relative to the substrate material being coated) as the substrate temperature can be kept low during processing avoiding damage, metallurgical changes and distortion to the substrate material.

The main advantage of this process over the similar combustion wire spray process is that a much wider range of materials can be easily processed into powder form giving a larger choice of coatings. The process is only limited by materials with higher melting temperatures than the flame can provide or if the material decomposes on heating.

### Limits and Applicability:

Flame spraying is noted for its relatively high as-deposited porosity, significant oxidation of the metallic components, low resistance to impact or point loading, and limited thickness (typically 0.5 to 3.5 mm). Advantages include the low capital cost of the equipment, its simplicity, and the relative ease of training the operators. In addition, the technique uses materials efficiently and has low associated maintenance costs.

### Specific Applications:

This technique can be used to deposit ferrous-based, nickel-based, as well as cobalt-based alloys and some ceramics. It is used in the repair of machine bearing surfaces, piston and shaft bearing or seal areas, and corrosion and wear resistance for boilers and structures, for example, bridges.

### Combustion Torch/High Velocity Oxygen Fuel (HVOF):

With HVOF, the coating is heated to near or above its melting point and accelerated in a high-velocity combustion gas stream. Continuous combustion of oxygen fuels typically occurs in a combustion chamber, which enables higher gas velocities (550 to 800 m/s). Typical fuels include propane, propylene, MAPP or hydrogen.

The HVOF Thermal Spray Process is basically the same as the combustion powder spray process (Low Velocity Oxygen Fuel—LVOF) except that this process has been developed to produce extremely high spray velocity. There are a number of HVOF guns which use different methods to achieve high velocity spraying. One method is basically a high pressure water cooled combustion chamber and long nozzle. Fuel (kerosene, acetylene, propylene and hydrogen) and oxygen are fed into the chamber. Combustion produces a hot high pressure flame which is forced down a nozzle increasing its velocity. Powder may be fed axially into the combustion chamber under high pressure or fed through the side of a laval type nozzle where the pressure is lower. Another method uses a simpler system of a high pressure combustion nozzle and air cap. Fuel gas (propane, propylene or hydrogen) and oxygen are supplied at high pressure, combustion occurs outside the nozzle but within an air cap supplied with compressed air. The compressed air pinches and accelerates the flame and acts as a coolant for the gun. Powder is fed at high pressure axially from the centre of the nozzle.

The coatings produced by HVOF are similar to those produce by the detonation process. Coatings are very dense, strong and show low residual tensile stress or in some cases compressive stress, which enable very much thicker coatings to be applied than previously possible with the other processes.

The very high kinetic energy of particles striking the substrate surface does not require the particles to be fully molten to form high quality coatings. This is certainly an advantage for the carbide cermet type coatings and is where this process really excels.

### Limits and Applicability:

This technique has very high velocity impact, and coatings exhibit little or no porosity. Deposition rates are relatively high and the coatings have acceptable bond strength. Coating thicknesses range from 0.00013 to 3 mm. Some oxidation of metallics or reduction of some oxides may occur, altering the coating's properties.

### Specific Applications:

This technique may be an effective substitute for hard chromium plating for certain jet engine components. Typical applications include reclamation of worn parts and machine element build-up, abradable seals and ceramic hard facings. HVOF coatings are used in applications requiring the highest density and strength found in most other thermal spray processes. New applications, previously not suitable for thermal spray coatings are becoming viable.

### Combustion Torch/Detonation Gun:

Using a detonation gun, a mixture of oxygen and acetylene with a pulse of powder is introduced into a water-cooled barrel about 1 meter long and 25 mm in diameter. A spark initiates detonation, resulting in a hot, expanding gas that heats and accelerates the powder materials (containing carbides, metal binders, oxides) so that they are converted into a plastic-like state at temperatures ranging from 1,100 to 19,000° C.

A complete coating is built up through repeated, controlled detonations.

The detonation gun basically consists of a long water cooled barrel with inlet valves for gases and powder. Oxygen and fuel (acetylene most common) is fed into the barrel along with a charge of powder. A spark is used to ignite the gas mixture and the resulting detonation heats and accelerates the powder to supersonic velocity down the barrel. A pulse of nitrogen is used to purge the barrel after each detonation. This process is repeated many times a second. The high kinetic energy of the hot powder particles on impact with the substrate result in a build up of a very dense and strong coating.

### Limits and Applicability:

This technology produces some of the densest of the thermal coatings. Almost any metallic, ceramic, or cement materials that melt without decomposing can be used to produce a coating. Typical coating thicknesses range from 0.05 to 0.5 mm, but both thinner and thicker coatings are used. Because of the high velocities, the properties of the coatings are much less sensitive to the angle of deposition than most other thermal spray coatings.

### Specific Applications:

This can only be used for a narrow range of materials, both for the choice of coating materials and as substrates. Oxides and carbides are commonly deposited. The velocity impact of materials such as tungsten carbide and chromium carbide restricts application to metal surfaces.

### Electric Arc Spraying:

During electric arc spraying, an electric arc between the ends of two wires continuously melts the ends while a jet of gas (air, nitrogen, etc.) blows the molten droplets toward the substrate at speeds of 30 to 150 m/s.

### Limits and Applicability:

Coating thicknesses can range from a few hundredths of a mm to almost unlimited thickness, depending on the end use. Electric arc spraying can be used for simple metallic coatings, such as copper and zinc, and for some ferrous alloys. The coatings have high porosity and low bond strength.

### Specific Applications:

Industrial applications include coating paper, plastics, and other heat sensitive materials for the production of electromagnetic shielding devices and mold making.

### Plasma Spraying:

A flow of gas (usually based on argon) is introduced between a water-cooled copper anode and a tungsten cathode. A direct current arc passes through the body of the gun and the cathode. As the gas passes through the arc, it is ionized and forms plasma. The plasma (at temperatures exceeding 30,000° C.) heats the powder coating to a molten state and compressed gas propels the material to the work piece at very high speeds that may exceed 550 m/s.

The plasma spray process is basically the spraying of molten or heat softened material onto a surface to provide a coating. Material in the form of powder is injected into a very high temperature plasma flame, where it is rapidly heated and accelerated to a high velocity. The hot material impacts on the substrate surface and rapidly cools forming a coating. This process carried out correctly is called a “cold process” (relative to the substrate material being coated) as the substrate temperature can be kept low during processing avoiding damage, metallurgical changes and distortion to the substrate material.

The plasma gun comprises a copper anode and tungsten cathode, both of which are water cooled. Plasma gas (argon, nitrogen, hydrogen, helium) flows around the cathode and through the anode which is shaped as a constricting nozzle. The plasma is initiated by a high voltage discharge which causes localized ionization and a conductive path for a DC arc to form between the cathode and anode. The resistance heating from the arc causes the gas to reach extreme temperatures, dissociate and ionize to form a plasma. The plasma exits the anode nozzle as a free or neutral plasma flame (plasma which does not carry electric current) which is quite different to the Plasma Transferred Arc Coating process where the arc extends to the surface to be coated. When the plasma is stabilized ready for spraying, the electric arc extends down the nozzle, instead of shorting out to the nearest edge of the anode nozzle. This stretching of the arc is due to a thermal pinch effect. Cold gas around the surface of the water cooled anode nozzle being electrically non-conductive constricts the plasma arc, raising its temperature and velocity. Powder is fed into the plasma flame most commonly via an external powder port mounted near the anode nozzle exit. The powder is so rapidly heated and accelerated that spray distances can be in the order of 25 to 150 mm.

The plasma spray process is most commonly used in normal atmospheric conditions. Some plasma spraying is conducted in protective environments using vacuum chambers normally back filled with a protective gas at low pressure.

Plasma spraying has the advantage that it can spray very high melting point materials such as refractory metals like tungsten and ceramics like zirconia unlike combustion processes. Plasma sprayed coatings are generally much denser, stronger and cleaner than the other thermal spray processes with the exception of HVOF and detonation processes. Plasma spray coatings probably account for the widest range of thermal spray coatings and applications and makes this process the most versatile.

### Limits and Applicability:

The thermal spray industry uses a variety of techniques to melt the materials being applied. Many of these methods use gas combinations consisting of (but not limited to) hydrogen, oxygen, nitrogen, argon, propane and LP. Some of the gases are used as fuel while others are used as atmospheric gases for bright or reducing atmospheres. The thermal spray industry has always suffered some drawbacks due to inherent problems with the process. Some of these are slow coating and application rates, unpredictable coated consistency, high porosity, expensive and cumbersome equipment. A typical combustion wire thermal spray process requires relatively complicated equipment and facilities and complicated processes to produce the coatings.

Currently, much of the thermal spray processes' short falls are created by the limits of the process itself. That is to say the high temperatures necessary to melt the materials in a high velocity stream are restricted by many factors of thermal dynamics and physics that cannot be improved upon so long as the current fuel is being used. These extreme temperatures destroy much of the ideal characteristics of the materials being applied and leave a coating that is a compromise (best that they can do approach).

### SUMMARY OF THE INVENTION

The invention that is the subject of this disclosure comprises of the use of a unique electrolytic water to gas generator in a thermal spray process. The generator, by its design, generates a combination of hydrogen and oxygen gas mixture in a stable form whose atomic structure causes the gas hereafter referred to as HHO, to burn with a flame temperature in open air of from 255° F. to 288° F. and when the flame comes into contact with most material surfaces, does combine by sublimation creating a catalyzing effect with the matter being impinged by the HHO gas flame that results in a rapid melting of the target material being impinged, which temperatures are dramatically increased by the sublimation and catalyzing effects of the gas flame on the materials. These temperatures have been measured from about 1200° F. to about 13,000° F. depending on the surface/materials being impinged by the HHO gas flame. For example, in a lab test conducted, the temperature reached nearly 13,000° F. reacting to a ceramic substrate. About 10,000° F. was reached melting tungsten and carbon steel can be melted at about 1200° F. The combined benefits of a self-contained water to gas generator which generates an unusual combination of HHO gas, which when lit generates a flame in open air with a temperature of from 255° F. to 288° F. and when the low temperature flame is impinged onto another material surface does react with that material in a specific way unique to reach different material through a combination of atomic, catalytic and sublimation reactions to produce temperatures unattainable by other hydrogen/oxygen gas combinations or by other typical fuels such as acetylene and oxygen combinations.

These variable temperatures can be controlled by the distance of the flame core from the substrate material, and also by the difference of the substrate itself, such as the ceramic or metal or a combination of either.

The novel HHO gas can be used as a substitute for typical fuels and heat sources applicable to specific prior art thermal spray coating processes or it can be used as a supplemental or additive to such fuels and heat sources. The amount of additive is determined by the characteristics desired and process being used.

Further, the HHO gas flame because of its instantaneous reaction with the target materials to generate a precise thermal reaction with that material, has shown useful to melt, heat treat, seal, weld, apply thermal sprayed coating materials or other thermal treatments to materials heretofore unattainable and to cause different reactions with each material impinged by the HHO gas flame allowing in many cases for the joining of dissimilar materials or the combining of materials heretofore not able to be combined technically or practically by other means.

The combined benefits heretofore stated regarding the gas generation, gas composition, gas flame reaction with other materials to create instantaneous temperatures which are capable of rapidly melting even the most difficult materials such as tungsten and the atomic modifying effects of the gas flame on the molecular structure of the impinged material offer benefits when used as a thermal spray coatings material and device, as a heat treatment device, welding device, cutting device, brazing and soldering device and for thermal processing of chemicals, gases and elements into materials with modified molecular structure.

### EXAMPLE USE OF THE INVENTION

As a simplistic example which will serve to demonstrate the unique characteristics of this invention, the following describes a thermal spray coating device which applies a wide variety of materials that include but which are not limited to, metal powders, ceramic powders, oxides, refractories, plastics, nitrides, glass and many other elements as well as wire made from these materials in singular or combined forms, which is fed into and through the HHO gas flame thereby being instantaneously melted and which is further propelled within the gas flame path by the natural pressure of the gas generator or as augmented by an external source or pressurized gas of choice, but preferably oxygen so as to impact the molten or semi-molten particles of the material being reacted (melted) by the gas flame, does impact a target/surface intended to be coated by the material and which material upon impact with the target/surface does bond with that surface through a combination of coadhesion, diffusion, mechanical and molecular bonding thereby forming a film/coating of the reacted material having been fed through the HHO gas flame. The films/coatings produced by this method have demonstrated superior bonds, uniformity, lower porosity, greater density, higher resistance to corrosion and thermal oxidation than the same materials applied by conventional thermal spray techniques such as Flame-Spray, Plasma Spray, Detonation Gun Applications and HVOC thereby providing films/coatings with greater utility when applied by this invention than those applied by other typical means.

### Historic Detail:

The science of generating hydrogen by electrolyses is well known and there are many electrolytic devices in common use which produce hydrogen and oxygen from water, however there are few, if any, that generate a combined hydrogen oxygen as a stochiometric mixture in a combined ratio of 2 parts hydrogen to 1 part oxygen which is generated in a single step as opposed to generating hydrogen from one side of the electrolytic plate, e.g. cathode and anode, which in current devices are usually extracted separately and used separately for the intended use or recombined in specific hydrogen oxygen ratios to provide a gas with a specific molecular structure. These typical electrolytic generators of hydrogen by their design generate hydrogen and oxygen separately which must be recombined at a later time should the two gases be desired together which in many instances can create a very explosive, unstable combination and which has limited commercial or technical value for the example of use being cited herein. The current electrolytic hydrolysis generators do not produce the combined hydrogen oxygen gas combination as does this invention. It has been found that the HHO gas produced by this invention provides special capabilities in sublimating with other materials that come in contact with a flame produced from this HHO gas and affords quicker melting of a given material than can be accomplished using typical fuels or even pure hydrogen.

Most current thermal spray coating units share a common design whether they are gas fuel or electric arc units; whether they are plasma or detonation gun units they all use high velocity jet streams to propel the molten and semi-molten particles of the coating. This is generally required by current technology in order to overcome the inconsistency of the materials being sprayed due to the systems inability to assure complete melting of the particles being applied, this is to say that because the particle mass being applied will vary from completely molten to semi-molten, to slightly plastic to un-melted altogether. This use of high velocity is an attempt to overcome these inconsistencies by impacting the target with the particles at high velocities thereby deforming them into a scale like effect of flat platelets. These platelets appear under a magnification as flattened droplets which are overlaid in a random nature having a combination of voids, un-melted particles, and oxides from the heating of the mass and melted particles. The chemical and physical coatings produced in this manner are less than effective and have many drawbacks, including voids, porosity, oxide inclusion, and un-melted particles. The variation in the physical properties of the materials being coated is due to the lack of the combustion, flame, heat, explosion or electric arc to produce enough heat across the entire material mass during spraying which will evenly and accurately heat each particle the same. This deficiency causes vast differences in the physical condition of the material particles being thermally applied to the point where some of the material is completely vaporized away, highly oxidized, melted, semi-melted creating an outer shell of molten metal with an inner core of un-melted metal (where metal is the material subject) and completely non-melted material. The thermal spray applied processed described herein (not including this invention) produce brittle, high porosity coatings with a wide variety of bond strengths to the base material being coated and generally fall short of producing coatings which have the same characteristics as the matrix formula of the coating raw materials. These disadvantages cause the thermal spray industry to be limited in efficiency, coating performance and predictability, economical applications and efficient application rates.

### ADVANTAGES OF THE CURRENT INVENTION

The current invention produces a stable gas from a self-contained small water electrolyzer unit which operates on either AC or DC current to energize the electrolyzer cells and which can be powered by either 110 or 220 volts at either 50 or 60 cycles, and which generates the combined gas from the unique electrolyzer cell design after which the HHO gas is cooled and stored for use as a fuel. The HHO Generator is small and compact and replaces typical thermal spray fuel and gas storage bottles which are both cumbersome and have some hazards associated with their handling and storage. Therefore a primary advantage to the HHO system is its self-contained small size which generates its gas fuel as required and on call without any storage problems presented by high pressure volatile gases.

As opposed to the high pressure gas fuel systems used by most current thermal spray coating systems, the current invention is a medium to low pressure system which ranges from 20 PSI to 60 PSI during operation of normal use, although the HHO gases can be generated at higher pressures if required, it has not been found to be advantageous us as a thermal spray coating gas fuel at such higher pressures.

Therefore, the invention is a thermal spray coating process for depositing finely divided metallic or nonmetallic materials in a molten or semi-molten condition to form a coating on a substrate wherein the coating material may be in the form of powder, ceramic-rod, wire or molten materials, the process comprising:

injecting as a fuel and flame source a gas made from water in an electrolyzer for the separation of water, the electrolyzer comprising:

an aqueous electrolytic solution comprising water, the aqueous electrolyte solution partially filling an electrolysis chamber such that a gas reservoir region is formed above the aqueous electrolyte solution, said chamber being adapted to be installed in a pressurized system;

two principal electrodes comprising an anode electrode and a cathode electrode, the two principal electrodes being at least partially immersed in the aqueous electrolyte solution;

a plurality of supplemental electrodes at least partially immersed in the aqueous electrolyte solution and interposed between the two principal electrodes wherein the two principal electrodes and the plurality of supplemental electrodes are held in a fixed spatial relationship, and wherein the supplemental electrodes are not connected electrically to a power source;

for each supplemental adjacent electrodes, one is made of a high porosity foam based material made substantially of a nickel material (preferably greater than 99% nickel in a foam material where the high porosity electrode results in a composite lattice-like configured electrode due to the use of foam and nickel fibers or powder) and the opposing electrode is made substantially of a stainless steel material, wherein said supplemental electrodes results in a (+) and (−) electrical (ionic) current flow that causes the formation of a single combustible gas over an entire surface area of both sides of all electrodes within the electrolyzer; and

said electrolyzer being adapted to separate the water such that its constituents of H and O are not recombined and instead produced jointly to make the single combustible gas composed of combinations of magnetically bonded clusters of hydrogen and oxygen atoms structured according to a general formula HₘOₙ wherein m and n have null or positive integer values with the exception that m and n can not be 0 at the same time,

wherein said combustible gas has a varying energy content depending on its use.

As mentioned above, this invention deals with the structure, properties and initial applications of a new clean burning combustible gas hereinafter called “HHO gas” produced from distilled water using a special electrolyzer described in detail in the specifications.

It will be soon evident that, despite a number of similarities, the HHO gas is dramatically different than the “Brown Gas” or other gases produced by pre-existing electrolyzers. In fact, the latter is a combination of conventional hydrogen and conventional oxygen gases, that is, gases possessing the conventional “molecular” structure, having the exact stochiometric ratio of 2/3 hydrogen and 1/3 oxygen. As we shall see, the HHO gas does not have such an exact stochiometric ratio but instead has basically a structure having a “magnecular” characteristic, including the presence of clusters in macroscopic percentages that cannot be explained via the usual valence bond. As a consequence, the constituents clusters of the Brown Gas and the HHO gas are dramatically different both in percentages as well as in chemical composition, as shown below.

The first remarkable feature of the special electrolyzers of this invention are their efficiencies. For example, with the use of only 4 Kwh, an electrolyzer rapidly converts water into 55 standard cubic feet (scf) of HHO gas at 35 pounds per square inch (psi). By using the average daily cost of electricity at the rate of $0.08/Kwh, the above efficiency implies the direct cost of the HHO gas of $0.007/scf. It then follows that the HHO gas is cost competitive with respect to existing fuels.

Under direct inspection, the HHO gas results to be odorless, colorless and lighter than air. A first basic feature in the production of the HHO gas is that there is no evaporation of water at all, and water is directly transmuted into the HHO gas. In any case, the electric energy available in the electrolyzer is basically insufficient for water evaporation.

This feature alone establishes that the special electrolyzers of this invention produce a “new form of water” which is gaseous and combustible. The main objective of this invention is the first identification on record of the produced unknown chemical composition of the HHO gas, its relationship with the special electrolyzers of this invention, and some initial applications.

The second important feature of the HHO gas is that it exhibits a “widely varying energy content” in British Thermal Units (BTU), ranging from a relatively cold flame in open air, to large releases of thermal energy depending on its use. This is a direct evidence of fundamental novelty in the chemical structure of the HHO gas.

In fact, all known fuels have a “fixed energy content” namely, a value of BTU/scf that remains the same for all uses. Also, the variable character of the energy content of the HHO gas is clear evidence that the gas has a magnecular characteristic in its structure, rather than a molecular structure, namely, that its chemical composition includes bonds beyond those of valence type.

The third important feature of the HHO gas is that it does not require any oxygen for its combustion since it contains in its interior all oxygen needed for that scope. By recalling that other fuels require atmospheric oxygen for their combustion, thus causing a serious environmental problem known as “oxygen depletion,” the capability to have combustion without any oxygen depletion renders the HHO gas particularly important on environmental grounds.

The fourth important feature of the HHO gas is its anomalous adhesion to gases, liquids and solids, as verified experimentally below, thus rendering its use particularly effective as an additive for the enhancement of desired qualities.

The fifth important feature of the HHO gas is that it does not follow the fundamental PVT law of all conventional gases (namely, those with molecular structure), since the HHO gas begins to deviate from this law at around 150 psi, and it reacquires the water state at a sufficiently high pressures beginning with 250 psi. These aspects are further being investigated for possible development and commercial exploitation.

The sixth and most important feature of the HHO gas is that it melts almost instantaneously tungsten, bricks, and other highly refractive substances. In particular, measurements have established the remarkable capability by the HHO gas of reaching almost instantaneously temperatures up to 13000 degrees F., namely a temperature of the order of that in the Sun chromosphere under which all substances on Earth can be sublimated.

The combustible gas produced when lighted as a flame in open air burns with a flame temperature at its core in said open air of from about 255° F. to about 288° F. When the flame comes into contact with a target material, the combustible gas combines by sublimation creating a catalyzing effect with the target material being impinged by the combustible gas flame that results in a rapid melting of the target material being impinged, which temperatures are dramatically increased by the sublimation and catalyzing effects of the gas flame on the target material. The temperatures can be varied depending on the target material being impinged by the combustible gas flame, wherein the target material is selected from refractive materials consisting of carbon steel, tungsten, bricks and ceramic materials.

The temperatures can also be varied depending on a percentage of mixture of the HHO gas with the other fuel and heat source being used in the process.

HHO gas when mixed with any other carbon based fuels produces a cleaner burn leaving no fumes to breathe.

This invention also involves an electrolyzer for the separation of water, as described above, wherein the electrolyzer produces a combustible gas composed of hydrogen and oxygen atoms and their bonds into chemical species caused by electrons valence bonds and the bond due to attractive forces between opposing magnetic polarities originating in the toroidal polarization of the electron orbitals. Furthermore, the relatively simple design of the electrodes—as rectangular or square metallic shapes allows for the electrodes to be easily replaced. The electrodes can be flat or have other shaped such as corrugated. The combustible gas is collected in the gas reservoir region, which is adapted to deliver the gas to the fuel system of one of a flame process, including thermal spray coating processes.

To further describe the electrolyzer, the anode electrode and cathode electrode slip into grooves in a rack. The rack is placed inside the chamber. One or more supplemental electrodes are also placed in the rack. Again, the supplemental electrodes are at least partially immersed in the aqueous electrolyte solution and interposed between the anode electrode and cathode electrode. Furthermore, anode electrode, cathode electrode, and supplemental electrodes are held in a fixed spatial relationship by rack. Preferably, anode electrode, cathode electrode, and supplemental electrodes are separated by a distance of about 0.15 to about 0.35 inches, preferably about 0.25 inches. The supplemental electrodes allow for enhanced and efficient generation of this gas mixture. Preferably, there are from 1 to 50 supplemental electrodes interposed between the two principal electrodes. More preferably, there are from 5 to 30 supplemental electrodes interposed between the two principal electrodes, and most preferably, there are about 15 supplemental electrodes interposed between the two principal electrodes. Preferably, the two principal electrodes are each individually a metallic wire mesh, a metallic plate, or a metallic plate having one or more holes. More preferably, the two principal electrodes are each individually a metallic plate. A suitable metal from which the two principal electrodes are formed, includes but is not limited to, nickel, nickel containing alloys, and stainless steel. The preferred metal for the two principal electrodes is nickel or a nickel alloy. A suitable metal from which the supplemental electrodes are formed, includes but is not limited to, nickel, nickel containing alloys, and stainless steel. The supplemental electrodes preferably are a metallic foam based lattice-like material such as INCOFOAM™ material, a metallic wire mesh, a metallic plate, or a metallic plate having one or more holes. Even more preferably, the supplemental electrodes are each individually a metallic nickel based material such as the INCOFOAM material. And in one even more preferable embodiment, it is preferred that alternating supplemental electrodes be made from a material which is substantially made from stainless steel or a stainless steel alloy that may contain some nickel. One example is a stainless steel electrode have about 14% nickel. The opposing adjacent supplemental electrodes would have an INCOFOAM material electrode which contains greater than 99% nickel. This INCOFOAM material is a high porosity foam lattice like material manufactured by the Inco Special Products Company of Wyckhoff, N.J. in the United States. One such electrode made by this company that was found to work extremely well was a light weight ultra pure and very high porosity foam like lattice material with a 99.8% wt. nickel having a density of 400-600 g/m³ and a tensile strength of 1.5 MPA and an elongation of 4.0%. Nickel content from this company's INCOFOAM products can be varied to lower content nickel to as low as 25% wt.; however, the better conductivity reaction was found using material with nickel content greater than 99% wt. nickel in the INCOFOAM product line. The INCOFOAM product's porous structure and uniform density, coupled with nickel's intrinsic strength, corrosion resistance, and high melting point make the INCOFAOM product especially useful as both a catalyst and a filter. The INCOFOAM material from which the preferred electrodes can be made are made from extra fine filamentary low apparent density nickel powders.

Of course, the principal electrodes could also be made by the same material used for the supplemental electrodes and any combination of the above materials could be used for the principal and/or supplemental electrodes.

During operation of the electrolyzer, a voltage is applied between the anode electrode and cathode electrode which causes the novel gas to be produced and which collects in a gas reservoir region. The gaseous mixture exits the gas reservoir region from through an exit port and ultimately is fed into the fuel system of an internal combustion engine. An electrical contact to anode electrode is made through a contactor and electrical contact to cathode electrode is made by another contactor. The contactors are preferably made from metal and are slotted with channels such that the contactors fit over the anode electrode and cathode electrode. The contactors are attached to rods, which slip through holes in the cover. Preferable the holes are threaded and the rods are threaded rods so that rods screw into the holes. The contactors also hold the rack in place since the anode electrode and cathode electrode are held in place by channels and by grooves in the rack. Accordingly, when the cover is bolted to the chamber, the rack is held at the bottom of the chamber. The electrolyzer optionally includes a pressure relief valve and a level sensor. The pressure relief valve allows the gaseous mixture in the gas reservoir to be vented before a dangerous pressure buildup can be formed. The level sensor ensures that an alert is sounded and the flow of gas to the vehicle fuel system is stopped when the electrolyte solution gets too low. At such time when the electrolyte solution is low, addition electrolyte solution is added through a water fill port. The electrolyzer may also include a pressure gauge so that the pressure in the reservoir may be monitored. Finally, the electrolyzer optionally includes one or more fins which remove heat from the electrolyzer.

As can be surmised by the above description, the electrolyzer is operated in a pressurized system, un-vented except for when a pressure relief valve may be activated.

In a variation of an electrolyzer, a first group of the one or more supplemental electrodes is connected to the anode electrode with a first metallic conductor and a second group of the one or more supplemental electrodes is connected to the cathode electrode with a second metallic conductor. The anode electrode, cathode electrode, and supplemental electrodes are held to the rack by a holder rod, which slips through channels in the rack and the holes in the electrodes. The rack is preferably fabricated from a high dielectric plastic such as PVC, polyethylene or polypropylene. Furthermore, the rack holds the anode electrode, cathode electrode, and supplemental electrodes in a fixed spatial relationship. Preferably, the fixed spatial relationship of the two principal electrodes and the one or more supplemental electrodes is such that the electrodes (two principal and one or more supplemental) are essentially parallel and each electrode is separated from an adjacent electrode by a distance from about 0.15 to about 0.35 inches. More preferably, each electrode is separated from an adjacent electrode by a distance from about 0.2 to about 0.3 inches, and most preferably about 0.25 inches. The fixed spatial relationship is accomplished by a rack that holds the two principal electrodes and the one or more supplemental electrodes in the fixed spatial relationship. The electrodes sit in grooves in the rack which define the separations between each electrode. Furthermore, the electrodes are removable from the rack so that the electrodes or the rack may be changed if necessary. Finally, since the rack and anode electrode and cathode electrode are held in place as set forth above, the supplemental electrodes are also held in place because they are secured to the rack by the holder rod.

During operation, the novel combustible gas is formed by the electrolysis of the electrolyte solution in the electrolyzer. The electrolyzer is connected to a collection tank by a pressure line. The gases are collected and temporarily stored in the collection tank. Optionally, the HHO gas can be routed through a magnetic centrifuge product, such as centrifuge model no. LG-X 200, sold under the trade name “Algae-x.” This additional step gives an additional magnetic bond to the gas as it ignites the powder to be sent into the thermo spray stream, causing a stronger bond to the product being sprayed and producing more adhesion thereby giving a far superior finished product.

### BRIEF DESCRIPTION OF THE DRAWINGS

In the accompanying drawings:

FIG. 1a depicts a conventional hydrogen atom with its distribution of electron orbitals in all space directions, thus forming a sphere;

FIG. 1b depicts the same hydrogen atom wherein its electron is polarized to orbit within a toroid resulting in the creation of a magnetic field along the symmetry axis of said toroid;

FIG. 2a depicts a conventional hydrogen molecule with some of the rotations caused by temperature;

FIG. 2b depicts the same conventional molecule in which the orbitals are polarized into toroids, thus causing two magnetic field in opposite directions since the hydrogen molecule is diamagnetic;

FIG. 3a depict the conventional water molecules H—O—H in which the dimers H—O and O—H form an angle of 105 degrees, and in which the orbitals of the two H atoms are polarized in toroids perpendicular to the H—O—H plane;

FIG. 3b depicts the central species of this invention consisting of the water molecule in which one valence bond has been broken, resulting in the collapse of one hydrogen atom against the other;

FIG. 4a depicts a polarized conventional hydrogen molecule;

FIG. 4b depicts a main species of this invention, the bond between two hydrogen atoms caused by the attractive forces between opposing magnetic polarities originating in the toroidal polarizations of the orbitals;

FIG. 5 depicts a new chemical species identified for the first time in this invention consisting of two dimers H—O of the water molecule in their polarized form as occurring in the water molecule, with consequential magnetic bond, plus an isolated and polarized hydrogen atom also magnetically bonded to the preceding atoms;

FIG. 6 depicts mass spectrometric scans of the HHO gas of this invention;

FIG. 7 depicts infrared scans of the conventional hydrogen gas;

FIG. 8 depicts infrared scans of the conventional oxygen gas;

FIG. 9 depicts infrared scans of the HHO gas of this invention;

FIG. 10 depicts the mass spectrography of the commercially available diesel fuel;

FIG. 11 depicts the mass spectrography of the same diesel fuel of the preceding FIG. 10 with the HHO gas of this invention occluded in its interior via bubbling;

FIG. 12 depicts an analytic detection of the hydrogen content of the HHO gas of this invention;

FIG. 13 depicts an analytic detection of the oxygen content of the HHO gas of this invention;

FIG. 14 depicts an analytic detection of impurities contained in the HHO gas of this invention;

FIG. 15 depicts the anomalous blank of the detector since it shows residual substances following the removal of the gas;

FIG. 16 depicts a scan confirming the presence in HHO of the basic species with 2 amu representing H—H and HxH, and the presence of a clean species with 5 amu that can only be interpreted as H—HxH—HxH;

FIG. 17 depicts a scan which provides clear evidence of a species with mass 16 amu that in turn confirms the presence in HHO of isolated atomic oxygen, and which confirms the presence in HHO of the species H—O with 17 amu and the species with 18 amu consisting of H—O—H and HxH—O;

FIG. 18 depicts a scan which establishes the presence in HHO of the species with 33 amu representing O—OxH or O—O—H, and 34 amu representing O—HxO—H and similar configurations;

FIG. 19 is an exploded view of one example of a preferred electrolyzer;

FIG. 20 is top view of a variation of an electrolyzer in which one group of supplemental electrodes are connected to the anode electrode and a second group of supplemental electrodes are connected to the cathode electrode;

FIG. 21 is a perspective view of the electrode plate securing mechanism for the electrolyzer of FIG. 20;

FIG. 22a is a conceptual representation of a prior art plasma thermal spray process with the exception that HHO gas is being substituted for or used as an additive to the fuel typically used for the process;

FIG. 22b is a conceptual representation of a prior art HVOF thermal spray process with the exception that HHO gas is being substituted for or used as an additive to the fuel typically used for the process;

FIG. 22c is a conceptual representation of a prior art detonation thermal spray process with the exception that HHO gas is being substituted for or used as an additive to the fuel typically used for the process; and

FIG. 23 is a conceptual depiction showing the routing of HHO gas through a magnetic centrifuge before be routed to the specific thermal spray process system being used.

### DETAILED DESCRIPTION OF THE INVENTION

A summary of the scientific representation of the preceding main features of the HHO gas is outlined below without formulae for simplicity of understanding by a broader audience.

Where the HHO gas originates from distilled water using a special electrolytic process described hereinafter, it is generally believed that such a gas is composed of 2/3 (or 66.66% in volume) hydrogen H2 and 1/2 (or 33.33% in volume) oxygen O2.

A fundamental point of this invention is the evidence that such a conventional mixture of H2 and O2 gases absolutely cannot represent the above features of the HHO gas, thus establishing the novel existence in the produced inventive HHO gas.

The above occurrence is established beyond any possible doubt by comparing the performance of the HHO gas with that of a mixture of 66.66% of H2 and 33.33% of O2. There is simply no condition whatsoever under which, the latter gas can instantly cut tungsten or melt bricks as done by the HHO gas, therein supporting the novelty in the chemical structure of the produced HHO gas.

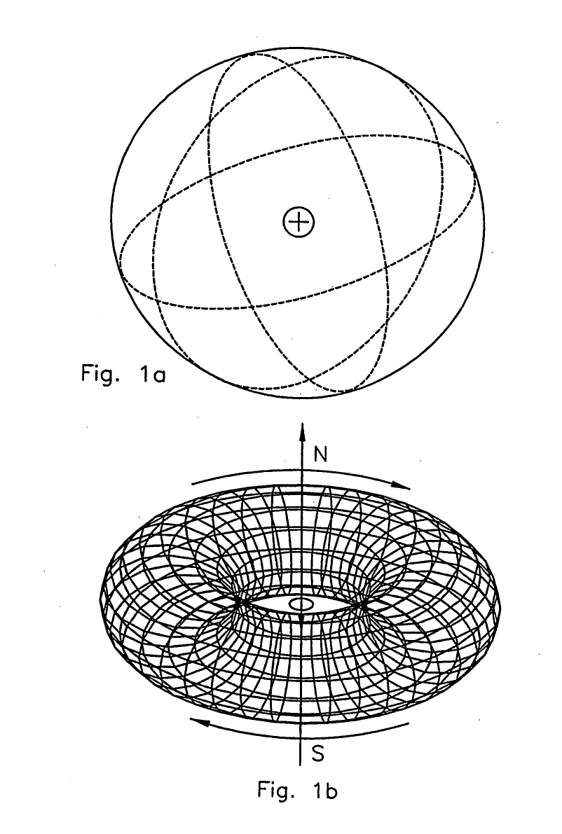

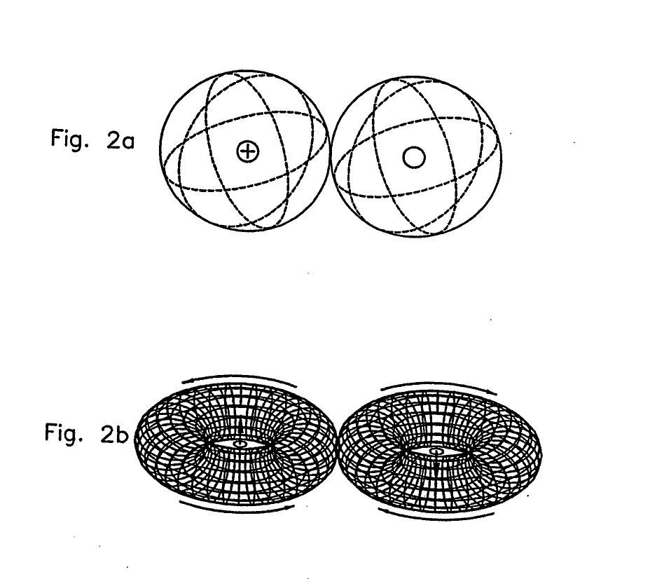

To begin the identification of the novelty in the HHO gas we note that the special features of the HHO gas, such as the capability of instantaneous melting tungsten and bricks, require that HHO contains not only “atomic hydrogen” (that is, individual H atoms without valence bond to other atoms as in FIG. 1a), but also “magnetically polarized atomic hydrogen”, that is, hydrogen atoms whose electrons are polarized to rotate in a toroid, rather than in all space directions, as per FIG. 1b.

It should be indicated that the Brown gas does assumes the existence of “atomic hydrogen”. However, calculations have established that such a feature is grossly insufficient to explain all the feature of the HHO gas, as it will be evidence in the following. The fundamental novelty of this invention is, therefore, the use of “polarized atomic hydrogen” as depicted in FIG. 1b.

Alternatively, in the event the hydrogen contained in the HHO gas is bonded to another atom, the dimension of the H2 molecules caused by thermal rotations (as partially depicted in FIG. 2a) are such to prevent a rapid penetration of hydrogen within deeper layers of tungsten or bricks, thus preventing their rapid melting. The only know configuration of the hydrogen molecule compatible with the above outlined physical and chemical evidence is that the molecule itself is polarized with its orbitals restricted to rotate in the oo-shaped toroid of FIG. 2b.

In fact, polarized hydrogen atoms as in FIG. 1b and polarized hydrogen molecules as in FIG. 2b are sufficiently thin to have a rapid penetration within deeper layers of substances. Moreover, the magnetic field created by the rotation of electrons within toroids is such so as to polarize the orbitals of substances when in close proximity, due to magnetic induction. But the polarized orbitals of tungsten and bricks are essentially at rest. Therefore, magnetic induction causes a natural process of rapid self-propulsion of polarized hydrogen atoms and molecules deep within substances.

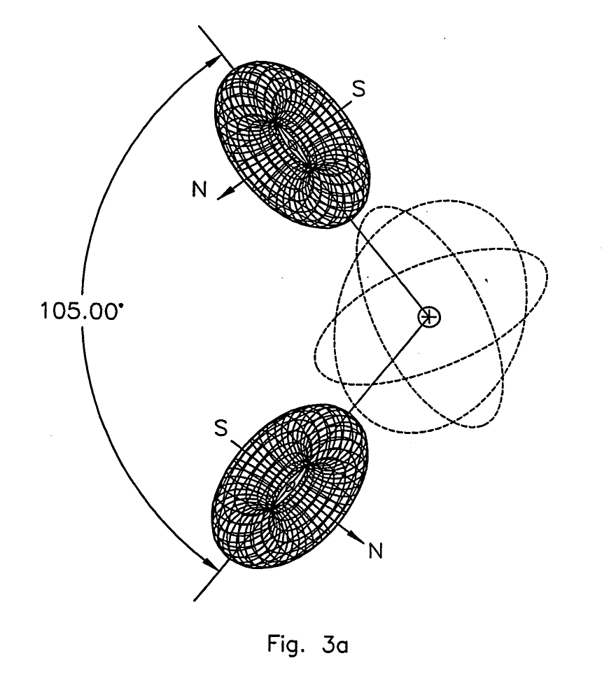

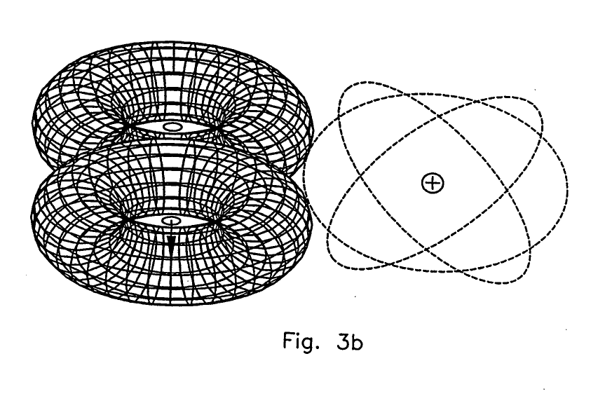

Nature has set the water molecule H2O=H—O—H in such a way that its H atoms do not have the spherical distribution of FIG. 1a, and have instead precisely the polarized distribution of FIG. 1b along a toroid whose symmetry plane is perpendicular to that of the H—O—H plane, as depicted in FIG. 3a, as established in the technical literature, e.g., in D. Eisenberg and W. Kauzmann, “The Structure and Properties of Water.” Oxford University Press (1969).

It is also known that the H—O—H molecule at ambient temperature and pressure, even though with a null total charge, has a high “electric polarization” (deformation of electric charge distributions) with the predominance of the negative charge density localized in the O atom and the complementary predominant positive charge density localized in the H atoms. This implies a repulsion of the H atoms caused by their predominantly positive charges, resulting in the characteristic angle of 105 degree between the H—O and O—H dimers as depicted in FIG. 3a.

Nevertheless, it is well established in quantum electrodynamics that toroidal polarizations of the orbitals of the hydrogen atom as in the configuration of FIG. 1b create very strong magnetic fields with a symmetry axis perpendicular to the plane of the toroid, and with a value of said magnetic fields that is 1,415 times bigger than the magnetic moment of the H-nucleus (the proton), thus having a value such to overcome the repulsive force due to charges.

It then follows that, in the natural configuration of the H—O—H molecule, the strong electric polarization caused by the oxygen is such to weaken the magnetic field of the toroidal polarization of the H-orbital resulting in the indicated repulsion of the two H-atoms in the H—O—H structure.

However, as soon as the strong electric polarization of H—O—H is removed, the very strong attraction between opposite polarities of the magnetic fields of the polarized H atom become dominant over the Coulomb repulsion of the charges, resulting in the new configuration of FIG. 3b that has been discovered in this invention.

The central feature of this invention is, therefore, that the special electrolyzer of this invention is such to permit the transformation of the water molecule from the conventional H—O—H configuration of FIG. 3a to the basically novel configuration of FIG. 3b, which latter configuration is, again, permitted by the fact that, in the absence of electric polarization, the attraction between opposite magnetic polarities of the toroidal distributions of the orbitals is much stronger than the Coulomb repulsion due to charges.

By denoting with “—” the valence bond and with “x” the magnetic bond, the water molecule is given by H—O—H (FIG. 3a) and its modified version in the HHO gas is given by HxH—O (FIG. 3b). As a result, according to the existing scientific terminology, as available, e.g., in R. M. Santilli, “Foundations of Hadronic Chemistry”, Kluwer Academic Publisher (2001), H—O—H is a “molecule,” because all bonds are of valence type, while HxH—O must be a specific “magnecular structure or cluster,” because one of its bonds is of magnecular type.

The validity of the above rearrangement of the water molecule is readily established by the fact that, when the species H—O—H is liquid, the new species HxH—O can be easily proved to be gaseous. This is due to various reasons, such as the fact that the hydrogen is much lighter than the oxygen in the ratio 1 atomic mass units (amu) to 16 amu. As a result, from a thermodynamical view point, the new species HxH—O is essentially equivalent to ordinary gaseous oxygen in full conformity with conventional thermodynamical laws, since the transition from liquids to gases implies an increase of entropy, as well known. This feature explains the creation by our special electrolyzer of a new form of gaseous water without any need for evaporation energy.

There are also other reason for which the transition from the H—O—H configuration of FIG. 3a to the HxH—O configuration of FIG. 3b implies the necessary transition from the liquid to the gaseous state. As it is established in the chemical literature (see D. Eisenberg and W Kauzmann quoted above), the liquid state of water at ambient temperature and pressure is caused by the so-called “hydrogen bridges,” namely a terminology introduced to represent the experimental evidence of the existence of “attractions between hydrogen atoms of different water molecules.”

However, the above interpretation of the liquid state of water remain essentially conceptual because it lacks completely the identification of the “attractive force” between different H atoms, as necessary for the very existence of the liquid state. Note that such attraction cannot be of valence type because the only available electron in the H atom is completely used for its bond in the H—O—H molecule. Therefore, the bridge force cannot credibly be of valence type.

The precise identification of the attractive force in the hydrogen bridges of water at the liquid state has been done by R. Santilli in the second above quoted literature, and has resulted to be precisely of magnecular type, in the sense of being due precisely to attraction between opposite magnetic polarities of toroidal distributions of orbitals that are so strong to overcome repulsive Coulomb forces. Therefore, the H—O—H can be correctly called a “molecule” because all bonds are of valence type, while the liquid state of water is composed of “magnecular clusters” because some of the bonds are of magnecular type.

In different terms, a central feature of this invention is that the transition from the H—O—H configuration to the new HxH—O one is essentially caused by the two H atoms establishing an “internal hydrogen bridge,” rather than the usual “external bridge with other H atoms. The first fundamental point is the precise identification of the “physical origin of the attractive force” as well as its “numerical value,” without which science is reduced to a mere political nomenclature.

In view of the above, it is evident that the transition from the H—O—H configuration of FIG. 3a to the HxH—O configuration of FIG. 3b implies the disruption of all possible hydrogen bridges, thus prohibiting the HxH—O magnecular cluster to be liquid at ambient temperature and pressure. This is due, e.g., to the rotation of the HxH dimer around the O atom under which no stable hydrogen bridge can occur.

In conclusion, the transition from the conventional H—O—H configuration of FIG. 3a to the new configuration HxH—O of FIG. 3b implies the necessary transition from the liquid to the gaseous state.

A first most important experimental verification of this invention is that the removal of the electric polarization of the water molecule, with consequential transition from the H—O—H to the new HxH—O configuration, can indeed be achieved via the minimal energy available in the electrolyzer and absolutely without the large amount of energy needed for water evaporation.

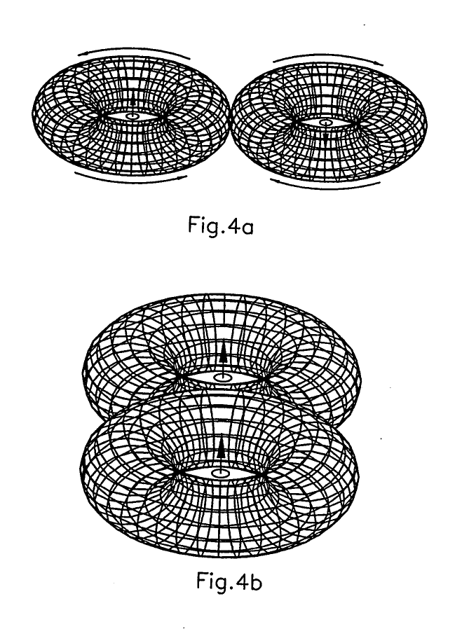

It is evident that the conventional H—O—H species is stable, while the new configuration HxH—O is unstable, e.g., because of collision due to temperature, thus experiencing its initial separation into the oxygen O and HxH. The latter constitutes a new chemical “species”, hereinafter referred to detectable “clusters” constituting the HHO gas, whose bond, as indicated earlier, originates from the attractive force between opposing magnetic polarities in the configuration when the toroidal orbitals are superimposed as depicted in FIG. 4b, rather than being of the conventional molecular type depicted in FIG. 4a.

The new chemical species HxH is another central novelty of this invention inasmuch as it contains precisely the polarized atomic hydrogen needed to explain physical and chemical evidence recalled earlier, the remarkable aspect being that these polarizations are set by nature in the water molecule, and mainly brought to a useful form by the inventive electrolyzer.

Note that one individual polarized atomic hydrogen, as depicted in FIG. 1b, is highly unstable when isolated because the rotations due to temperatures instantaneously cause said atom to recover the spherical distribution of FIG. 1a.

However, when two or more polarized H atoms are bonded together as in FIG. 4b, the bond is fully stable at ambient temperature since all rotations now occur for the coupled H-atoms. It then follows that the size of the HxH species under rotation due to temperature is one half the size of an ordinary H molecule, since the radius of the preceding species is that of one H atom, while the radius of the later species is the diameter of one H atom. In turn, this reduction in size is crucial, again, to explain the features of the HHO gas.

Needless to say, it is possible to prove via quantum chemistry that the HxH species has a 50% probability of converting into the conventional H—H molecule. Therefore, the hydrogen content of the HHO gas is predicted to be given by a mixture of HxH and H—H that, under certain conditions, can be 50%-50%.

The H—H molecule has a weight of 2 atomic mass units (amu). The bond in HxH is much weaker than the valence bond of H—H. Therefore, the species HxH is predicted to be heavier than the conventional one H—H (because the binding energy is negative). However, such a difference is of the order of a small fraction of one amu, thus being beyond the detecting abilities of currently available analytic instruments solely based on mass detection. It ten follows that the species HxH and H—H will appear to be identical under conventional mass spectrographic measurements since both will result to have the mass of 2 amu.

The separation and detection of the two species HxH and H—H require very accurate analytic equipment based on magnetic resonances, since the HxH species has distinct magnetic features that are completely absent for the H—H species, thus permitting their separation and identification. In this patent application, experimental evidence is presented based on conventional mass spectrometry.

It should be also noted that the weaker nature of the bond HxH over the conventional valence bond H—H is crucial for the representation of physical and chemical evidence. The sole interpretation of the latter is permitted by “polarized atomic hydrogen,” namely, isolated hydrogen atoms without valence bonds with the polarization of FIG. 1b.

It is evident that the conventional hydrogen molecule H—H does not allow a representation of said physical and chemical evidence precisely in view of the strong valence bond H—H that has to be broken as a necessary condition for any chemical reaction. By comparison, the much weaker magnecular bond HxH permits the easy release of individual hydrogen atoms, precisely as needed to represent experimental data. As a matter of fact, this evidence is so strong to select the new HxH species as the only one explaining physical and chemical behavior of the HHO gas, since the conventional H—H species absolutely cannot represent such evidence as stressed above.

The situation for the oxygen atom following its separation in the H—O—H molecule is essentially similar to that of hydrogen. When the oxygen is a member of the H—O—H molecule, the orbitals of its two valence electrons are not distributed in all directions in space, but have a polarization into toroids parallel to the corresponding polarizations of the H atoms.

It is then natural to see that, as soon as one H-valence bond is broken, and the two H atoms collapse one against the other in the HxH—O species, the orbitals of the two valance electrons of the O atom are correspondingly aligned. This implies that, at the time of the separation of the HxH—O species into HxH and O, the oxygen has a distinct polarization of its valence orbitals along parallel toroids. In addition, the oxygen is paramagnetic, thus quite responsive to a toroidal polarization of the valence electrons as customary under magnetic induction when exposed to a magnetic field.

It then follows that the oxygen contained in the HHO gas is initially composed of the new magnecular species OxO, that also has a 50% probability of converting into the conventional molecular species O—O, resulting in a mixture of OxO and O—O according to proportions that can be, under certain conditions, 50%-50%.

The O—O species has the mass of 32 amu. As in the case for HxH, the new species OxO has a mass bigger than 32 amu due to the decrease in absolute value of the binding energy (that is negative) and the consequential increase of the mass. However, the mass increase is of a fraction of one amu, thus not being detectable with currently available mass spectrometers.

It is easy to see that the HHO gas cannot be solely composed of the above identified mixture of HxH/H—H and OxO/O—O gases and numerous additional species are possible. This is due to the fact that, valence bonds ends when all valence electrons are used, in which case no additional atom can be added. On the contrary, magnecular bonds such as that of the HxH structure of FIG. 4b have no limit in the number of constituents, other than the limits sets forth by temperature and pressure.

In the order of increased values of amu, we therefore expect in the HHO gas the presence of the following additional new species.

First, there is the prediction of the presence of a new species with 3 amu consisting of HxHxH as well as H—HxH. Note that the species H—H—H is impossible since the hydrogen has only one valence electron and valance bonds only occur in pairs as in H—H, thus prohibiting the triplet valence bonds H—H—H.

It should be recalled that a species with 3 amu, thus composed of three H atoms, has already been identified in mass spectrometry. The novelty of this invention is the identification of the fact that this species is a magnecular cluster HxH—H and not the molecule H—H—H, since the latter is impossible.

Next, there is the prediction of traces of a species with 4 amu that is not the helium (since there is no helium in water) and it is given instead by the magnecular cluster (H—H)x(H—H) having essentially the same atomic mass of the helium. Note that the latter species is expected to exist only in small traces (such as parts per million) due to the general absence in the HHO gas of polarized hydrogen molecules H—H needed for the creation of the species (H—H)—(H—H).

Additional species with more than four hydrogen atoms are possible, but they are highly unstable under collisions due to temperature, and their presence in the HHO gas is expected to be in parts per millions. Therefore, no appreciable species is expected to exist in the HHO gas between 4 amu and 16 amu (the latter representing the oxygen).

The next species predicted in the HHO gas has 17 amu and consists of the magnecular cluster HxO that also has a 50% transition probability to the conventional radical H—O. Detectable traces of this species are expected because they occur in all separations of water.

The next species expected in the HHO gas has the mass of 18 amu and it is given by the new magnecular configuration of the water HxH—O of FIG. 3b. The distinction between this species and the conventional water molecule H—O—H at the vapor state can be easily established via infrared and other detectors.

The next species expected in the HHO gas has the mass of 19 amu and it is given by traces the magnecular cluster HxH—O—H or HxH—O—H. A more probable species has the mass of 20 amu with structure HxH—O—HxH.

Note that heavier species are given by magnecular combination of the primary species present in the HHO gas, namely, HxH and OxO. We therefore have a large probability for the presence of the species HxH—OxO with 34 amu and HxH—OxO—H with 35 amu.

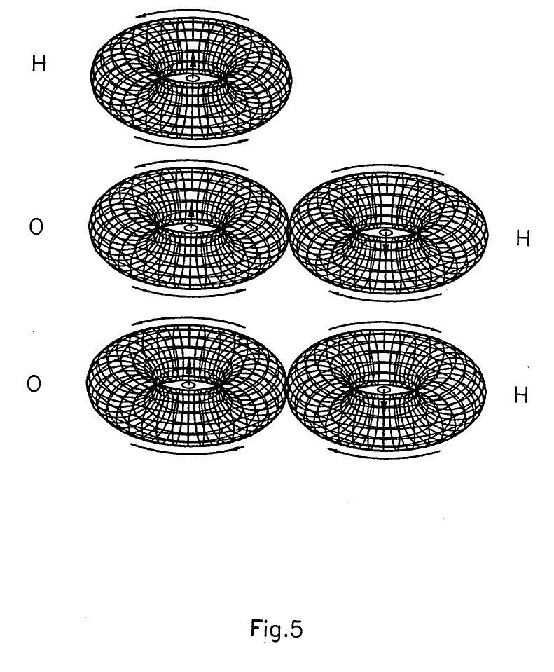

The latter species is depicted in FIG. 5 and consists of two conventional dimers H—O of the water molecule under bond caused by opposite polarities of the magnetic fields of their polarized valence electron orbitals, plus an additional hydrogen also bonded via the same magnecular law.

Additional heavier species are possible with masses re-presentable with the simple equation m×1+n×16 amu, where m and n are an integer value of 0 or greater, except the case where both m and n are 0, although their presence is expected to be of the order of parts per million.

In summary, a fundamental novelty of this invention relates to the prediction, to be verified with direct measurements by independent laboratories outlined below, that the HHO gas is constituted by:

i) two primary species, one with 2 amu (representing a mixture of HxH and H—H) in large percentage yet less than 66% in volume, and a second one with 32 amu (representing a mixture of OxO and O—O) in large percentage yet less than 33% in volume;

ii) new species in smaller yet macroscopic percentages estimated to be in the range of 8%-9% in volume comprising: 1 amu representing isolated atomic hydrogen; 16 amu representing isolated atomic oxygen; 18 amu representing H—O—H and HxH—O; 33 amu representing a mixture of HxOxO and HxO—O; 36 amu representing a mixture of HxH—O—OxHxH and similar configurations; and 37 amu representing a mixture of HxH—O—OxHxHxH and equivalent configurations; plus

iii) traces of new species comprising: 3 amu representing a mixture of HxHxH and HxH—H; 4 amu representing a mixture of H—HxH—H and equivalent configurations; and numerous additional possible species in part per million with masses bigger than 17 amu characterized by the equation n×1+m×16, where n and m can have integer values 1, 2, 3, and so on.

The preceding theoretical considerations can be unified in the prediction that the HHO combustible gas is composed of hydrogen and oxygen atoms bonded into clusters HₘOₙ in which m and n have integer values with the exclusion of the case in which both m and n are zero. In fact: for m=1, n=0 we have atomic hydrogen H; for m=0, n=1, we have atomic oxygen O; for m=2 and n=0 we have the ordinary hydrogen molecule H₂=H—H or the magnecular cluster HxH; for m=0 and n=2 we have the ordinary oxygen molecule O₂=O—O or the magnecular cluster OxO; for m=1, n=1 we have the radical H—O or the magnecular cluster HxO; for m=2 n=1 we have water vapor H—O—H or the predicted new species of water (FIG. 3b) HxH—O; for m=3, n=2 we have the magnecular clusters HxH—O—H or HxHxH—O; for m=3, n=3 we have the magnecular clusters HxHxH—OxO or (H—O—H)xO; and so on.

As we shall see below, “all” the above predicted magnecular clusters have been identified experimentally, thus confirming the representation of the chemical structure of the HHO combustible gas with the symbol HₘOₙ where m and n assume integer values with the exception of both m and n being 0.

The above definition of the HHO gas establishes its dramatic difference with the Brown gas in a final form.

### Outline of the Experimental Evidence:

On Jun. 30, 2003, scientific measurements on the specific weight of the HHO gas were conducted at Adsorption Research Laboratory in Dublin, Ohio. The resultant value was 12.3 grams per mole. The same laboratory repeated the measurement on a different sample of the gas and confirmed the result.

The released value of 12.3 grams per mole is anomalous. The general expectation is that the HHO gas consist of a mixture of H2 and O2 gases since the gas is produced from water. This implies a mixture of H2 and O2 with the specific weight (2+2+32)/3=11.3 grams per mole corresponding to a gas that is composed in volume of 66.66% H2 and 33.33% O2.

Therefore, we have the anomaly of 12.3-11.2=1 gram per mole, corresponding to 8.8% anomalous value of the specific weight. Therefore, rather than the predicted 66.66% of H2 the gas contains only 60.79% of the species with 2 amu, and rather than having 33.33% of O2 the gas contains only 30.39 of the species with 32 amu.

These measurements provide direct experimental confirmation that the HHO gas is not composed of a sole mixture of H2 and O2, but has additional species. Moreover, the gas was produced from distilled water. Therefore, there cannot be an excess of O2 over H2 to explain the increased weight. Therefore, the above measurement establish the presence in HHO of 5.87% of H2 and 2.94% O2 bonded together into species heavier than water to be identified via mass spectroscopy.

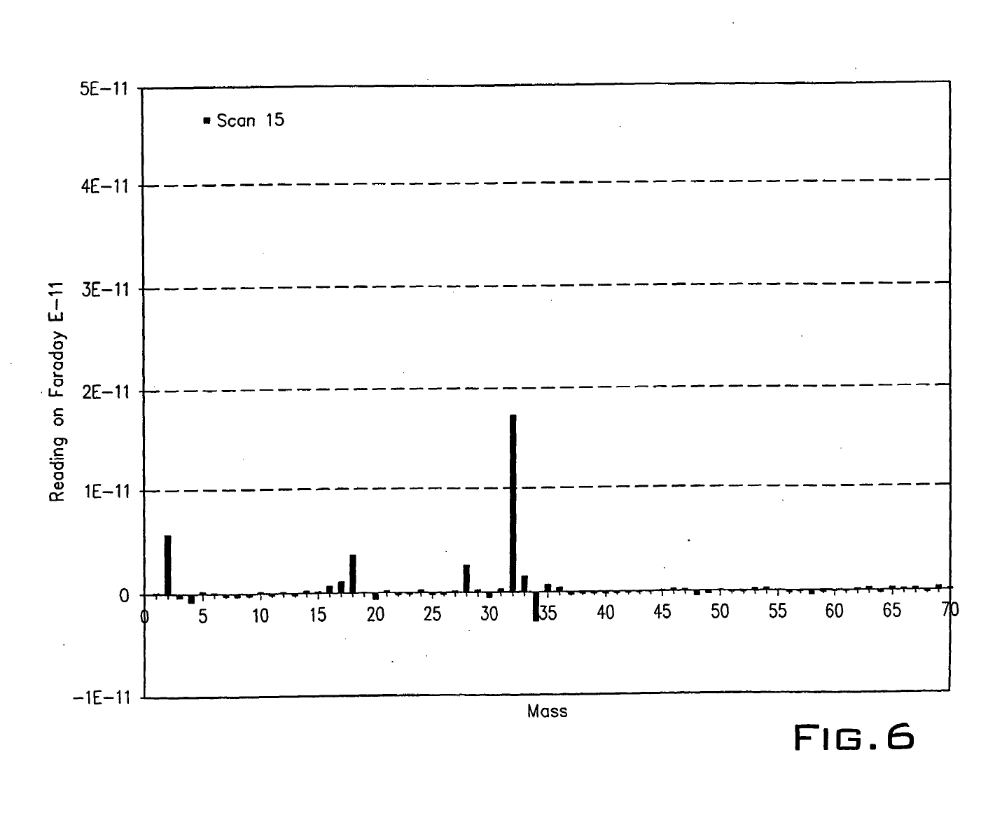

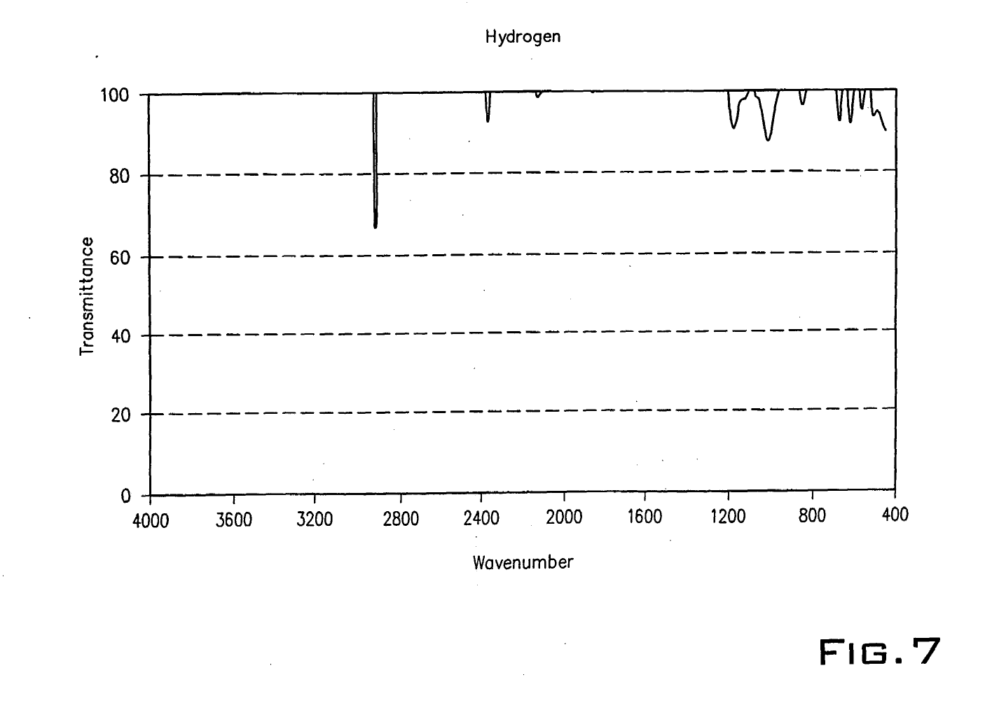

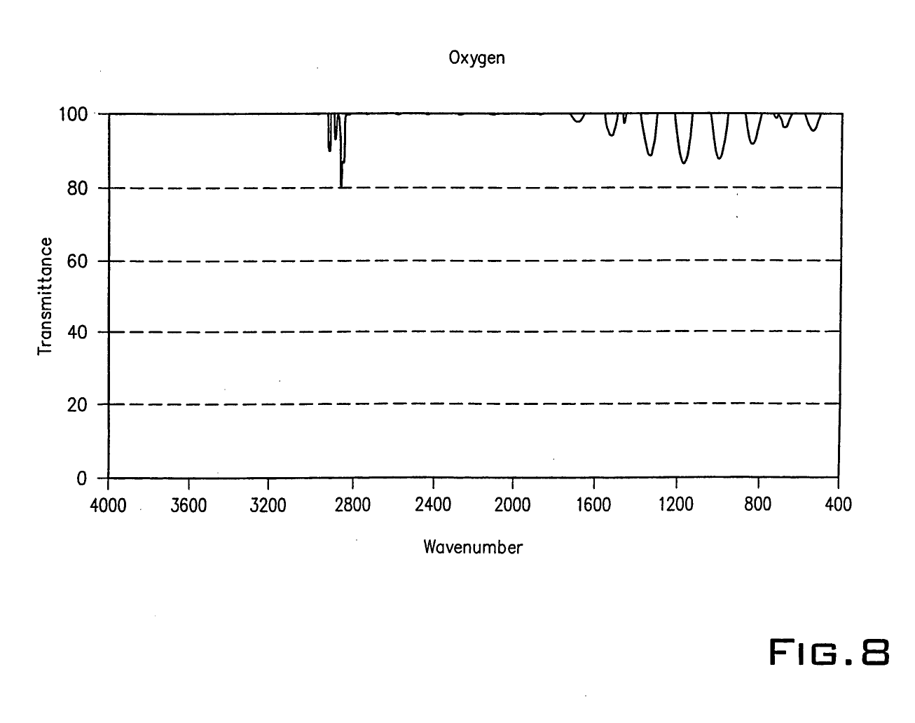

Adsorption Research Laboratory also conducted gas chromatographic scans of the HHO gas reproduced in FIG. 6 confirming most of the predicted constituents of this invention. In fact, the scans of FIG. 6 confirm the presence in the HHO gas of the following species here presented in order of their decreasing percentages:

1) A first major species with 2 amu representing hydrogen in the above indicated indistinguishable combination of magnecular HxH and molecular H—H versions;

2) A second major species with 32 amu representing the above indicated combination of the magnecular species OxO and the molecular one O—O;

3) A large peak at 18 amu that is established by other measurements below not to be water, thus leaving as the only rational explanation the new form of water HxH—O at the foundation of this invention;

4) A significant peak with 33 amu that is a direct experimental confirmation of the new species in the HHO gas given by HxH—OxH;

5) A smaller yet clearly identified peak at 16 amu representing atomic oxygen;

6) Other small yet fully identified peaks at 17 amu, confirming the presence of the mixture of the magnecular cluster HxO and radical H—O;

7) A small yet fully identified peak at 34 amu confirming the presence of the new species (H—O)x(H—O);

8) A smaller yet fully identified peak at 35 amu confirming the prediction of the new species (H—O)x(H—O)xH; and

9) numerous additional small peaks expected to be in parts per million.

It should be added that the operation of the IR detector was halted a few seconds following the injection of the HHO gas, while the same instrument was operating normally with other gases. This occurrence is a direct experimental verification of the magnetic features of the HHO gas because the behavior can only be explained by the clogging up of the feeding line by the HHO gas via its anomalous adhesion to the internal walls of the line due to magnetic induction, clogging that progressively occurred up to the point of preventing the gas to be injected into the instrument due to the small sectional area of the feeding line, with consequential halting of the instrument.

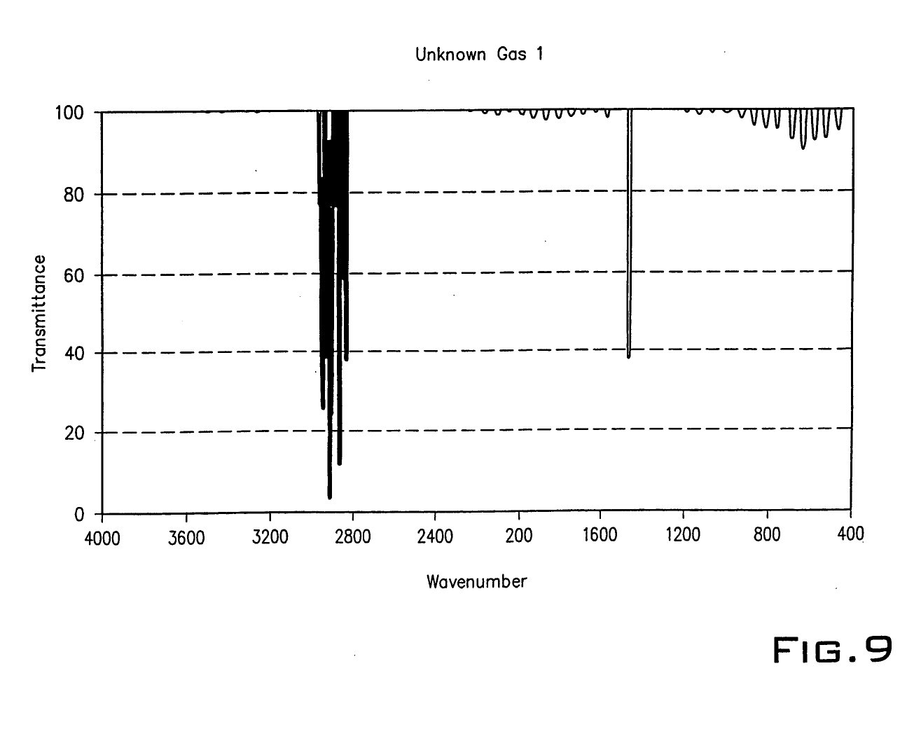

On Jul. 22, 2003, the laboratory of the PdMA Corporation in Tampa, Fla. conducted infrared scans reported in FIGS. 7, 8 and 9 via the use of a Perkin-Elmer InfraRed (IR) scanner with fixed point/single beam, model 1600. The reported scans refer to 1) a conventional H2 gas (FIG. 7); 2) a conventional O2 gas (FIG. 8); and 3) the HHO gas (FIG. 9).

The inspection of these scans shows a substantial difference between HHO gas and H2 and O2 gases. H2=H—H and O2=O—O are symmetric molecules. Therefore, they have very low IR peaks, as confirmed by the enclosed scans. The first anomaly of HHO is that of showing comparatively much stronger resonating peaks. Therefore, the enclosed IR scan of HHO first establish that the HHO gas has an asymmetric structure, that is a rather remarkable feature since the same feature is absence for the presumed mixture if H2 and O2 gases.

Moreover, H2 and O2 gases can have at most two resonating frequencies each, under infrared spectroscopy, one for the vibrations and the other for rotations. Spherical distributions of orbitals and other features imply that H2 has essentially only one dominant IR signature as confirmed by the scan of FIG. 7, while O2 has one vibrational IR frequency and three rotational ones, as also confirmed by the scans of FIG. 8.

The inspection of the IR scans for the HHO gas in FIG. 9 reveals additional novelties of this invention. First the HHO scan reveals the presence of at least nine different IR frequencies grouped around wavenumber 3000 plus a separate distinct one at around wavenumber 1500.

These measurements provide the very important experimental confirmation that the species with 18 amu detected in the IR scans of FIG. 6 is not given by water, thus leaving as the only possibility a direct experimental verification of the fundamental novel species HxH—O of this invention.

In fact, the water vapor with molecules H—O—H has IR frequencies with wavelengths 3756, 3657, 1595, their combination and their harmonics (here ignored for simplicity). The scan for the HHO gas in FIG. 7 confirms the presence of an IR signature near 1595, thus confirming the molecular bond H—O in the magnecular structure HxH—O, but the scan shows no presence of the additional very strong signatures of the water molecules at 3756 and 3657, thus establishing the fact that the peak at 18 amu is not water as conventionally understood in chemistry.

On Jul. 22, 2003, the laboratory of the PdMA Corporation in Tampa, Fla. conducted measurements on the flash point, first on commercially available diesel fuel, measuring a flash point of 75 degrees C., and then of the same fuel following the bubbling in its interior of the HHO gas, measuring the flash point of 79 degrees C.

These measurements too are anomalous because it is known that the addition of a gas to a liquid fuel reduces its flash point generally by half, thus implying the expected flash value of about 37 degrees C. for the mixture of diesel and HHO gas. Therefore, the anomalous increase of the flash point value is not of 4 degrees C., but of about 42 degrees C.

Such an increase cannot be explained via the assumption that HHO is contained in the diesel in the form of a gas, and requires the necessary occurrence of some type of bond between the HHO gas and the liquid fuel. The latter cannot possibly be of valence type, but it can indeed be of magnetic type due to induced polarization of the diesel molecules by the polarized HHO gas and consequential adhesion of the constituents of the HHO gas to the diesel molecule.

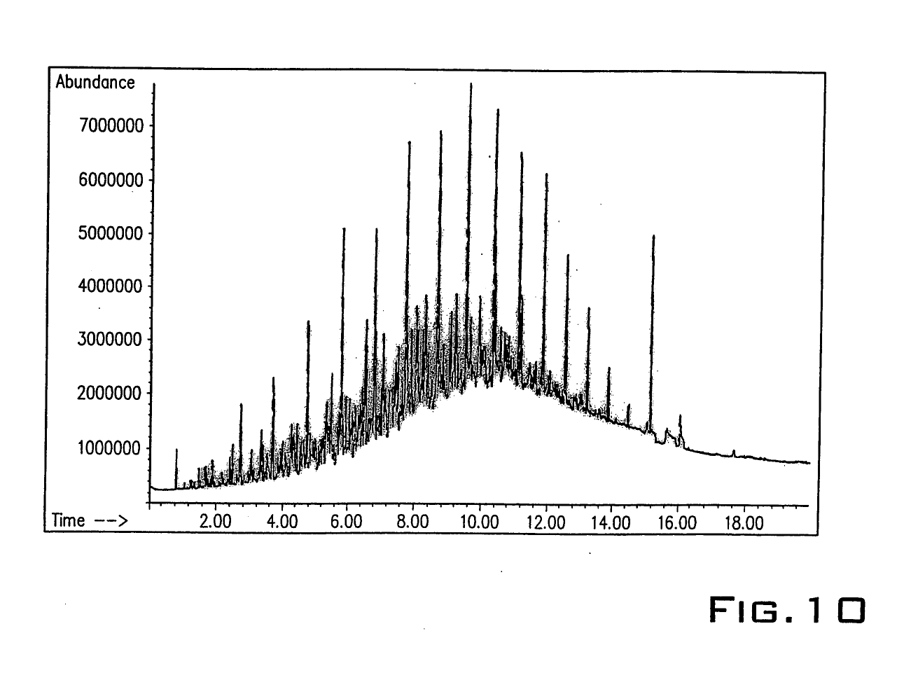

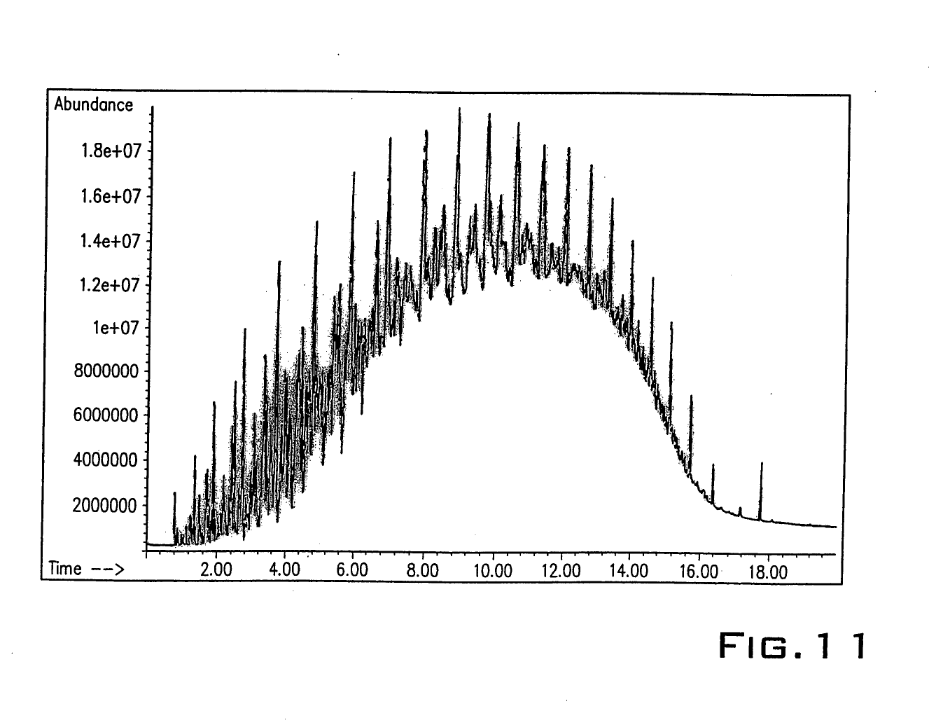

A major experimental confirmation of the latter bond was provided on Aug. 1, 2003, by the Southwest Research Institute of Texas, that conducted mass spectrographic measurements on one sample of ordinary diesel marked “A” as used for the above flash point value of 75 degrees C., here reported in FIG. 10, and another sample of the same diesel with HHO gas bubbled in its interior marked “B”, here reported in FIG. 11.

The measurements were conducted via a Total Ion Chromatogram (TIC) via Gas Chromatography Mass Spectrometry GC-MS manufactures by Hewlett Packard with GC model 5890 series II and MS model 5972. The TIC was obtained via a Simulated Distillation by Gas Chromatography (SDGC).

The used column was a HP 5MS 30×0.25 mm; the carrier flow was provided by Helium at 50 degrees C. and 5 psi; the initial temperature of the injection was 50 degrees C. with a temperature increase of 15 degrees C. per minute and the final temperature of 275 degrees C.

The chromatogram of FIG. 10 confirmed the typical pattern, elusion time and other feature of commercially available diesel. However, the chromatograph of the same diesel with the HHO gas bubbled in its interior of FIG. 11 shows large structural differences with the preceding scan, including a much stronger response, a bigger elusion time and, above all, a shift of the peaks toward bigger amu values.

Therefore, the latter measurements provide additional confirmation of the existence of a bond between the diesel and the HHO gas, precisely as predicted by the anomalous value of the flash point. In turn such a bond between a gas and a liquid cannot possibly be of valence type, but can indeed be of magnetic type via induced magnetic polarization of the diesel molecules and consequential bond with the HHO magnecular clusters.

In conclusion, the experimental measurements of the flash point and of the scans of FIGS. 10 and 11 establish beyond doubt the existence in the HHO gas of a magnetic polarization that is the ultimate foundation of this invention.

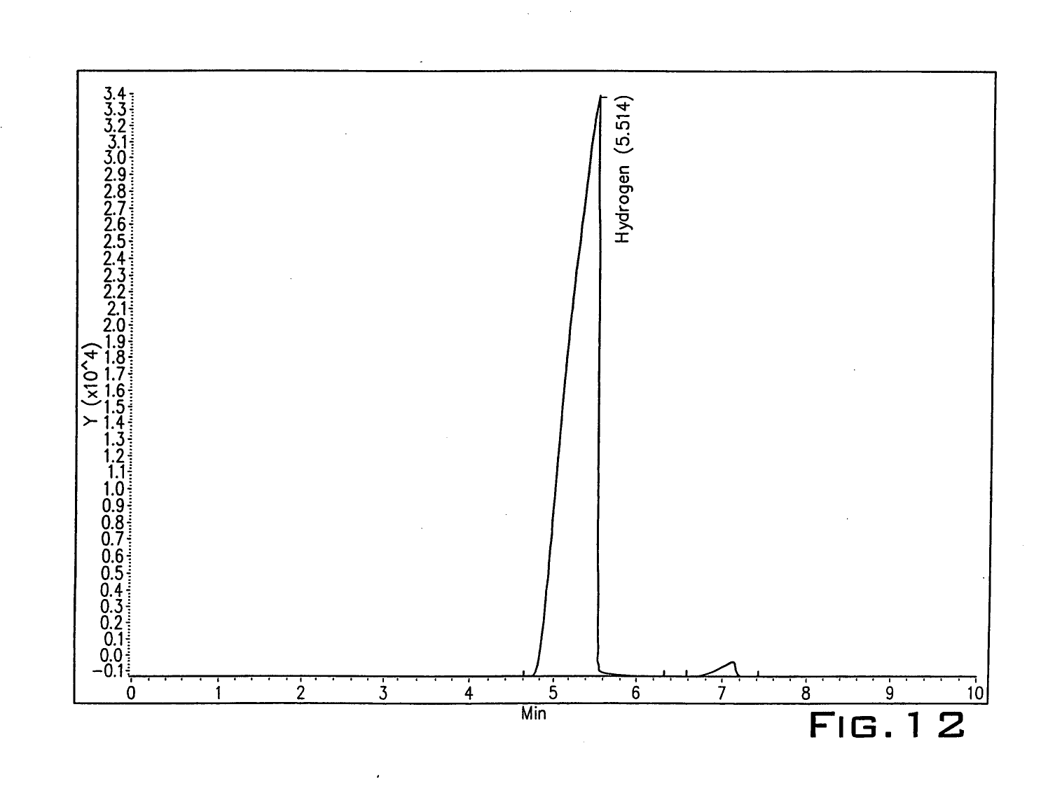

Additional chemical analyses on the chemical composition of the HHO gas were done by Air Toxic LTD of Folsom, Calif. via the scans reproduced in FIGS. 12, 13 and 14 resulting in the confirmation that H2 and O2 are the primary constituents of the HHO gas. However, the same measurements imply the identification of the following anomalous peaks:

a) A peak in the H2 scan at 7.2 minutes elusion times (FIG. 12);

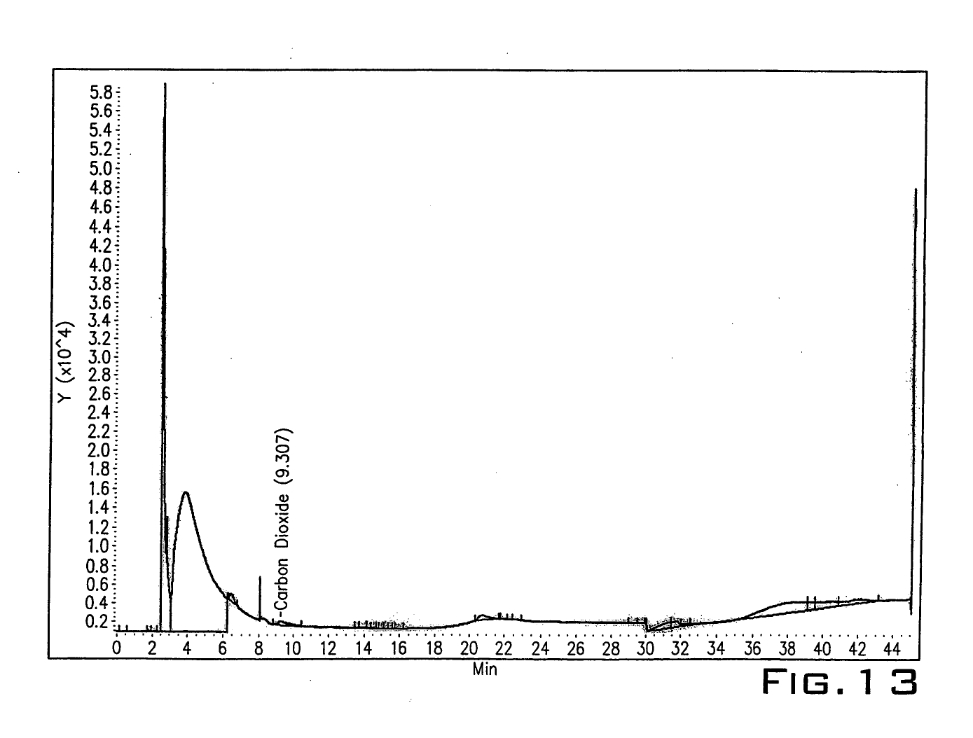

b) A large peak in the O2 scan at 4 minutes elusion time (FIG. 13); and

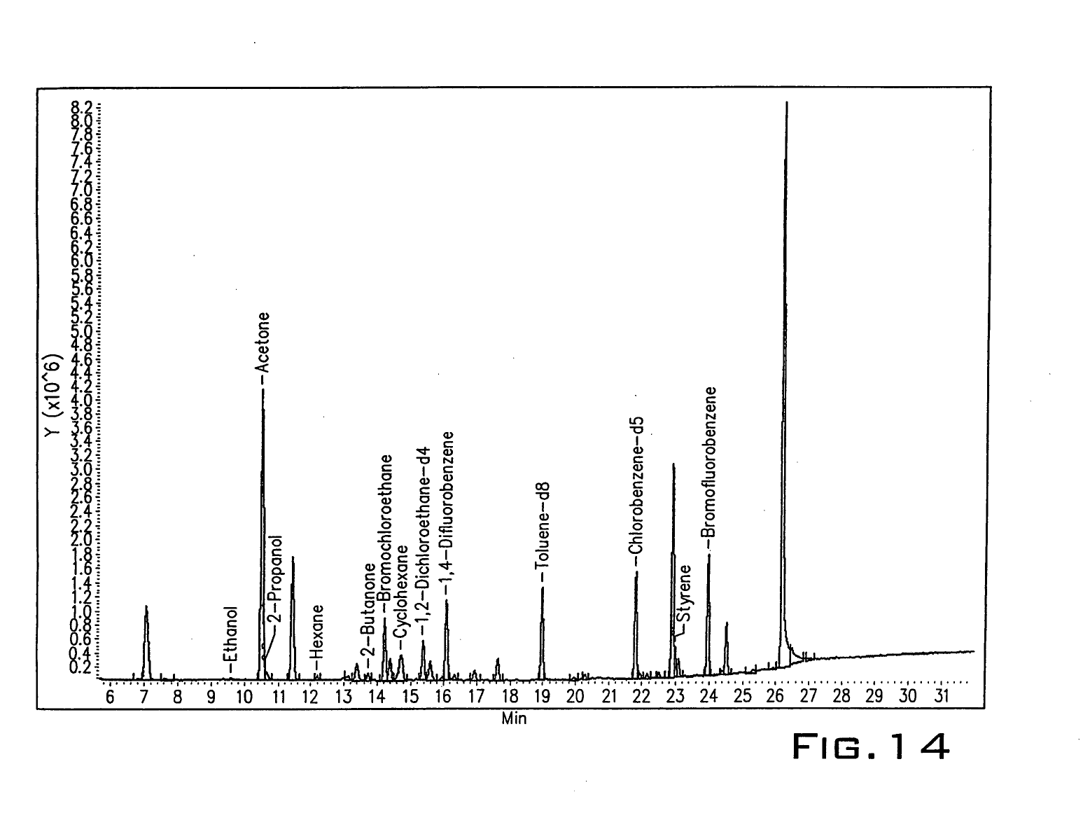

c) A number of impurities contained in the HHO gas (FIG. 14).

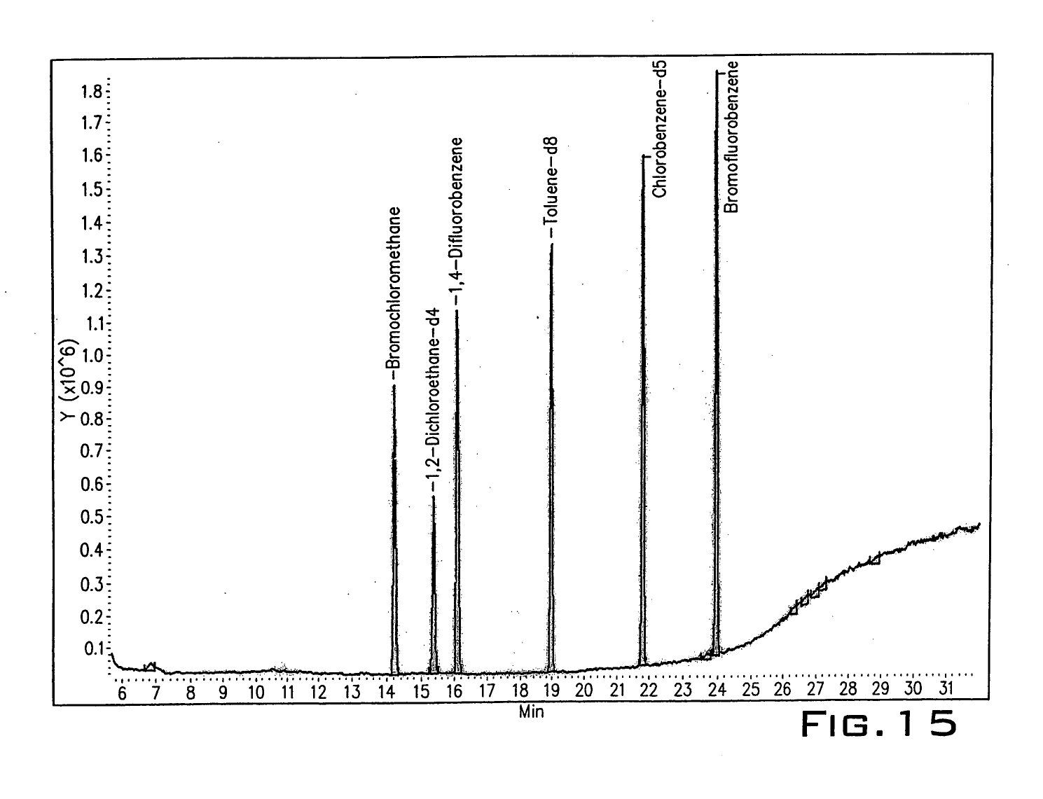

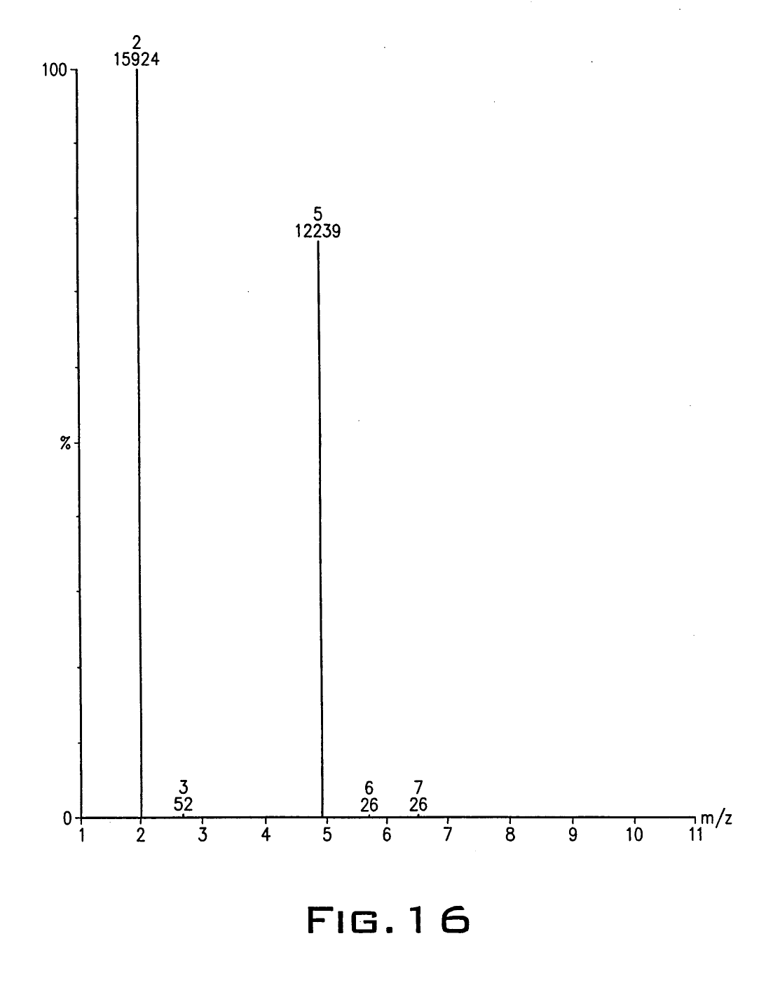

FIG. 15 depicts the anomalous blank of the detector since it shows residual substances following the removal of the gas. The blank following the removal of the HHO gas is anomalous because it shows the preservation of the peaks of the preceding scans, an occurrence solely explained by the magnetic polarization of species and their consequential adhesion to the interior of the instrument via magnetic induction.

Unfortunately, the equipment used in the scans of FIGS. 12, 13, 14 cannot be used for the identification of atomic masses and, therefore, the above anomalous peaks remain unidentified in this test.

Nevertheless, it is well know that species with bigger mass elude at a later time. Therefore, the very presence of species eluding after the H₂ and the O₂ detection is an additional direct experimental confirmation of the presence in the HHO gas of species heavier than H₂ and

O₂, thus providing additional experimental confirmation of the very foundation of this invention.

Final mass spectrographic measurements on the HHO gas were done on Sep. 10, 2003, at the SunLabs, located at the University of Tampa in Florida via the use of the very recent GC-MS Clarus 500 by Perkin Elmer, one of the most sensitive instruments capable of detecting hydrogen.

Even though the column available at the time of the test was not ideally suited for the separation of all species constituting HHO, the measurements have fully confirmed the predictions i), ii) and iii) above on the structure of the HHO gas.

In fact, the Scan of FIG. 16 confirm the presence in HHO of the basic species with 2 amu representing H—H and HxH, although their separation was not possible in the Clarus 500 GC-MS. The same instrument also cannot detect isolated hydrogen atoms due to insufficient ionization. The species with 4 amu representing H—HxH—H could not be detected because helium was the carrier gas and the peak at 4 amu had been subtracted in the scan of FIG. 16. Note however the presence of a clean species with 5 amu that can only be interpreted as H—HxH—HxH.

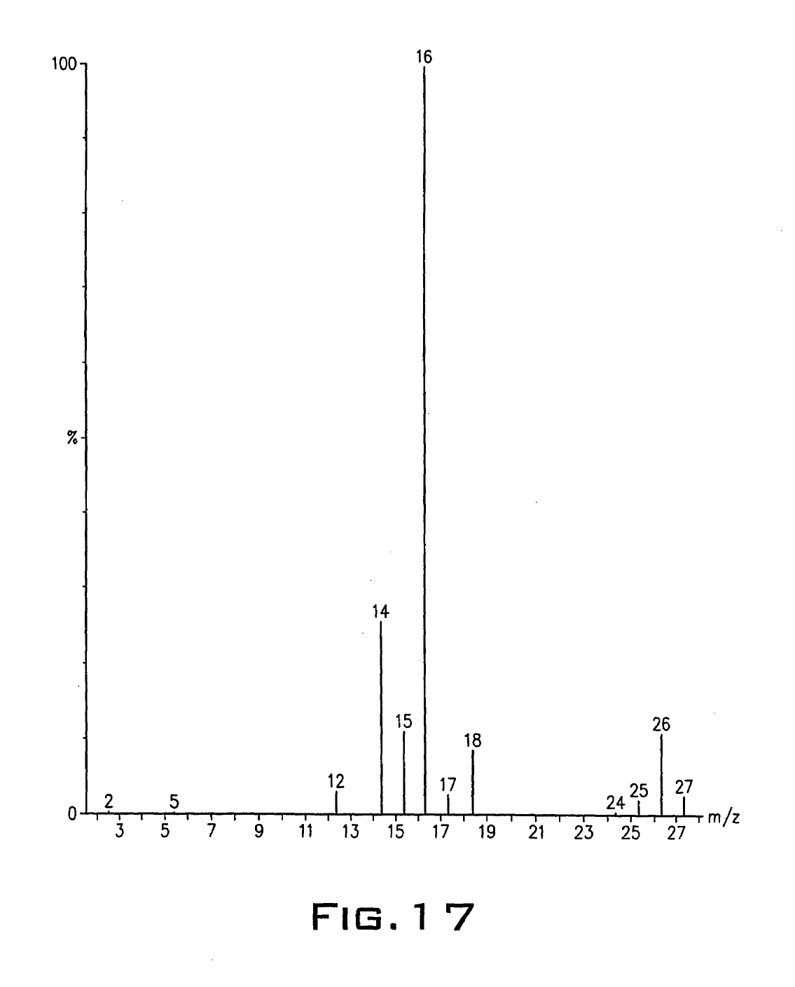

The scan of FIG. 17 provides clear evidence of a species with mass 16 amu that confirms the presence in HHO of isolated atomic oxygen, thus providing an indirect confirmation of the additional presence of isolated hydrogen atoms due to the impossibility of their detection in the instrument. The same scan of FIG. 17 confirms the presence in HHO of the species H—O with 17 amu and the species with 18 amu consisting of H—O—H and HxH—O, whose separation is not possible in the instrument here considered.

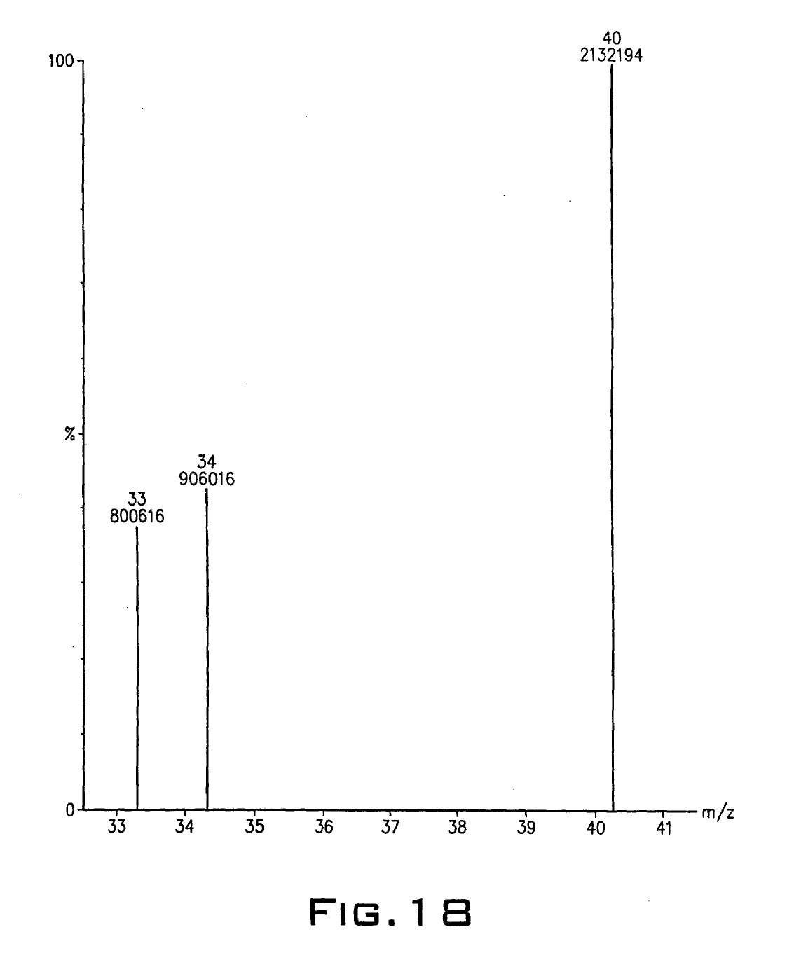

The scan of FIG. 18 clearly establishes the presence in HHO of the species with 33 amu representing O—OxH or O—O—H, and 34 amu representing O—HxO—H and similar configurations, while the species with 35 amu detected in preceding measurements was confirmed in other scans.

The test also confirmed the “blank anomaly” typical of all gases with magnecular structure, namely, the fact that the blank of the instrument following the removal of the gas continues to detect the basic species, which scan is not reproduced here for simplicity, thus confirming the anomalous adhesion of the latter to the instrument walls that can only be explained via magnetic polarization.

In conclusion, all essential novel features of this invention are confirmed by a plurality of direct experimental verifications. In fact:

I) The excess in specific weight of 1 gram/mole (or 8.8%) confirms the presence of species heavier than the predicted mixture of H2 and O2, thus confirming the presence of a species composed of H and O atoms that cannot possibly have a valence bond.

II) The IR scans done by Adsorption Research (FIG. 6) clearly confirm all new species above predicted for the HHO gas, thus providing a basic direct experimental verification of this invention;

III) The halting of the IR instrument in the scans of FIG. 6 after one or two seconds following the injection of HHO, while the same instrument works normally for conventional gases, is a direct experimental confirmation of the presence of magnetic polarization in the HHO gas, as routinely detected also for all gases having a magnecular structure, and it is due to the clogging of the feeding line by the HHO species via magnetic induction with consequential adhesion to the walls of the feeding line, consequential impossibility for the gas to enter in the instrument, and subsequent automatic shut off of the instrument itself.

IV) The large increase of the flash point of diesel fuel following inclusion of the HHO gas also constitutes direct clear experimental evidence of the magnetic polarization of the HHO gas since it provides the only possible explanation, namely, a bond between a gas and a liquid that cannot possibly be of valence type, but that can indeed be of magnetic type due to magnetic induction.

V) The mass spectrometric measurements on the mixture of diesel and HHO (FIGS. 10 and 11) provide final experimental confirmation of the bond between HHO and diesel. In turn, this bond establishes the capability of the species in HHO to polarize via magnetic induction other atoms, thus confirming the chemical composition of the HHO gas.

VI) The additional scans of FIG. 12-18 confirms all the preceding results, including the anomalous blank following the removal of the HHO gas that confirms the magnetic polarization of the HHO gas at the foundation of this invention.

VII) The capability by the HHO gas to melt instantaneously tungsten and bricks is the strongest visual evidence on the existence in the HHO gas of isolated and magnetically polarized atoms of hydrogen and oxygen, that is, atoms with a much reduced “thickness” that allows their increased penetration within the layers of other substances, plus the added penetration due to magnetic induction, a feature typical of all gases with magnecular structure.

It should be noted that the above experimental verifications confirm in full the representation of the HHO combustible gas with the symbol HₘOₙ where m and n assume integer values with the exception in which both m and n have the value 0. In fact, the various analytic measurements reported above confirm the presence of: atomic hydrogen H (m=1, n=0); atomic oxygen O (m=0, n=1); hydrogen molecule H—H or magnecular cluster HxH (m=2, n=0); oxygen molecule O—O or magnecular cluster OxO (m=0, n=2); radical H—O or magnecular cluster HxO (m=1, n=1); water vapor H—O—H or magnecular cluster HxH—O (m=2, n=1); magnecular cluster HxHxH—O or HxH—OxH (n=3, n=1); magnecular cluster HxHxH—OxO or HxH—O—OxH (m=3, n=2); etc.

For ease in understanding the parts of an electrolyzer and operations functions of the parts, the following general definitions are provided.

The term “electrolyzer” as used herein refers to an apparatus that produces chemical changes by passage of an electric current through an electrolyte. The electric current is typically passed through the electrolyte by applying a voltage between a cathode and anode immersed in the electrolyte. As used herein, electrolyzer is equivalent to electrolytic cell.

The term “cathode” as used herein refers to the negative terminal or electrode of an electrolytic cell or electrolyzer. Reduction typically occurs at the cathode.

The term “anode” as used herein refers to the positive terminal or electrode of an electrolytic cell or electrolyzer. Oxidation typically occurs at the cathode.

The term “electrolyte” as used herein refers to a substance that when dissolved in a suitable solvent or when fused becomes an ionic conductor. Electrolytes are used in the electrolyzer to conduct electricity between the anode and cathode.

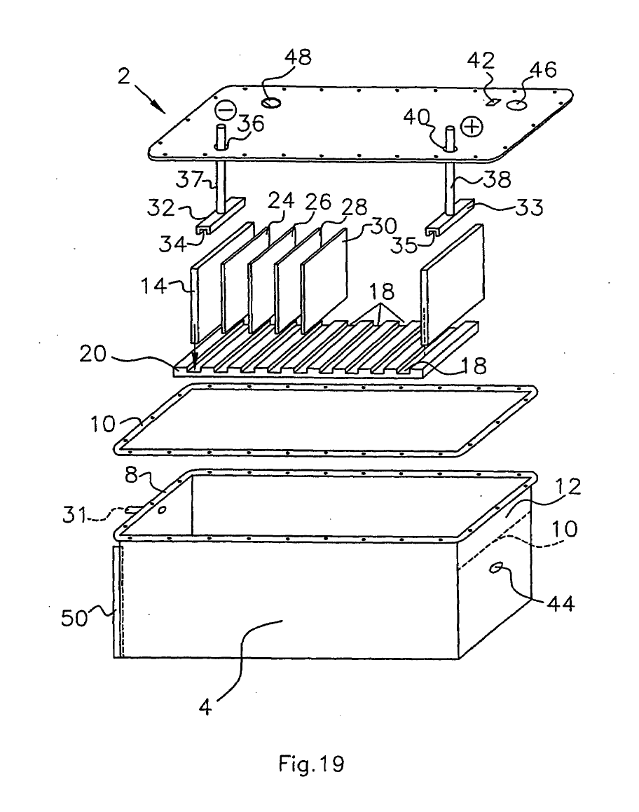

With reference to FIG. 19, an exploded view of an electrolyzer is provided. Electrolyzer 2 includes electrolysis chamber 4 which holds an electrolyte solution. Electrolysis chamber 4 mates with cover 6 at flange 8. Preferably, a seal between chamber 4 and cover 6 is made by neoprene gasket 10 which is placed between flange 8 and cover 6. The electrolyte solution may be an aqueous electrolyte solution of water and an electrolyte to produce a mixture of the novel gases; however, to produce the novel inventive gases, distilled water preferably is used.

The electrolyte partially fills electrolysis chamber 4 during operation to level 10 such that gas reservoir region 12 is formed above the electrolyte solution. Electrolyzer 2 includes two principle electrodes—anode electrode 14 and cathode electrode 16—which are at least partially immersed in the electrolyte solution. Anode electrode 14 and cathode electrode 16 slip into grooves 18 in rack 20. Rack 20 is placed inside chamber 4. A plurality of supplemental electrodes 24, 26, 28, 30 are also placed in rack 16 (not all the possible supplemental electrodes are illustrated in FIG. 19.) Again, supplemental electrodes 24, 26, 28, 30 are at least partially immersed in the aqueous electrolyte solution and interposed between the anode electrode 14 and cathode electrode 16. Furthermore, anode electrode 14, cathode electrode 16, and supplemental electrodes 24, 26, 28, 30 are held in a fixed spatial relationship by rack 20. Preferably, anode electrode 14, cathode electrode 16, and supplemental electrodes 24, 26, 28, 30 are separated by a distance of about 0.25 inches. The supplemental electrodes allow for enhanced and efficient generation of this gas mixture. Preferably, there are from 1 to 50 supplemental electrodes interposed between the two principal electrodes. More preferably, there are from 5 to 30 supplemental electrodes interposed between the two principal electrodes, and most preferably, there are about 15 supplemental electrodes interposed between the two principal electrodes.

Still referring to FIG. 19, during operation of electrolyzer 2 a voltage is applied between anode electrode 14 and cathode electrode 16 which causes the novel gas to be produced and which collects in gas reservoir region 12. The gaseous mixture exits gas reservoir region 12 from through exit port 31 and ultimately is fed into the fuel system of an internal combustion engine. Electrical contact to anode electrode 14 is made through contactor 32 and electrical contact to cathode electrode 16 is made by contactor 33. Contactors 32 and 33 are preferably made from metal and are slotted with channels 34, 35 such that contactors 32, 33 fit over anode electrode 14 and cathode electrode 16. Contactor 32 is attached to rod 37 which slips through hole 36 in cover 6. Similarly, contactor 33 is attached to rod 38 which slips through hole 40 in cover 6. Preferable holes 36, 40 are threaded and rods 37, 38 are threads rods so that rods 37, 38 screw into holes 36, 40. Contactors 32 and 33 also hold rack 20 in place since anode electrode 14 and cathode electrode 16 are held in place by channels 34, 35 and by grooves 18 in rack 20. Accordingly, when cover 6 is bolted to chamber 4, rack 20 is held at the bottom of chamber 4. Electrolyzer 2 optionally includes pressure relief valve 42 and level sensor 44. Pressure relief 42 valve allows the gaseous mixture in the gas reservoir to be vented before a dangerous pressure buildup can be formed. Level sensor 44 ensures that an alert is sounded and the flow of gas to the vehicle fuel system is stopped when the electrolyte solution gets too low. At such time when the electrolyte solution is low, addition electrolyte solution is added through water fill port 46.

Electrolyzer 2 may also include pressure gauge 48 so that the pressure in reservoir 4 may be monitored. Finally, electrolyzer 2 optionally includes one or more fins 50, which remove heat from electrolyzer 2.

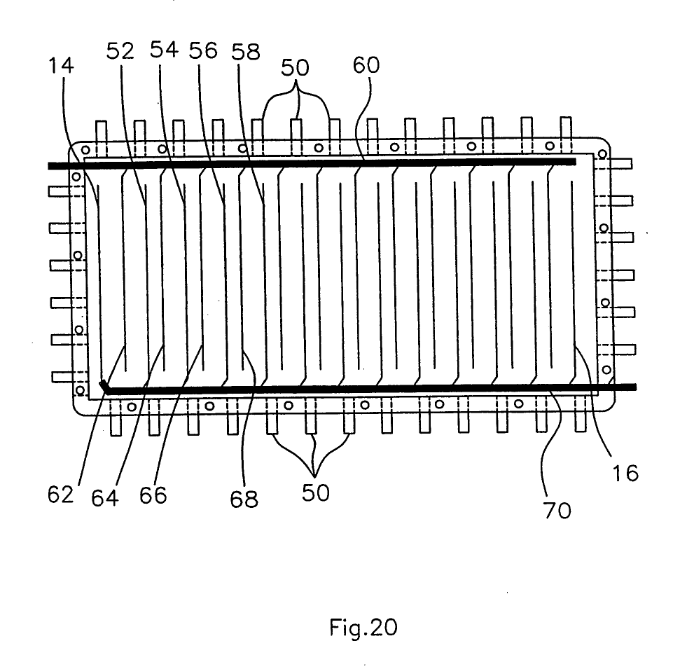

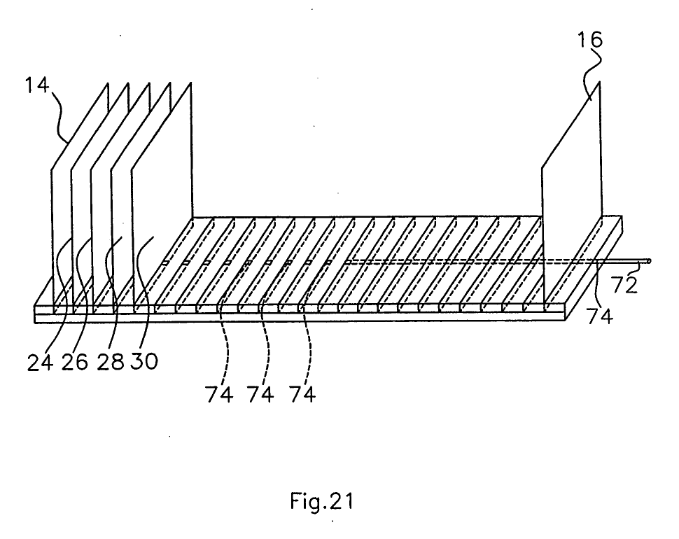

With reference to FIG. 20, a variation of an electrolyzer is provided. A first group of the one or more supplemental electrodes 52, 54, 56, 58 is connected to anode electrode 14 with a first metallic conductor 60 and a second group of supplemental electrodes 62, 64, 66, 68 is connected to cathode electrode 16 with second metallic conductor 70. With reference to FIG. 21, a perspective view showing the electrode plate securing mechanism is provided. Anode electrode 14, cathode electrode 16, and supplemental electrodes 24, 26, 28, 30 are held to rack 20 by holder rod 72 which slips through channels 74 in rack 20 and holes in the electrodes (not all the possible supplemental electrodes are illustrated in the drawings). Rack 20 is preferably fabricated from a high dielectric plastic such as PVC, polyethylene or polypropylene. Furthermore, rack 20 holds anode electrode 14, cathode electrode 16, and supplemental electrodes 24, 26, 28, 30 in a fixed spatial relationship. Preferably, the fixed spatial relationship of the two principal electrodes and the supplemental electrodes is such that the electrodes (two principal and plurality of supplemental electrodes) are essentially parallel and each electrode is separated from an adjacent electrode by a distance from about 0.15 to about 0.35 inches. More preferably, each electrode is separated from an adjacent electrode by a distance from about 0.2 to about 0.3 inches, and most preferably about 0.25 inches. The fixed spatial relationship is accomplished by a rack that holds the two principal electrodes and the one or more supplemental electrodes in the fixed spatial relationship. The electrodes sit in grooves in the rack which define the separations between each electrode. Furthermore, the electrodes are removable from the rack so that the electrodes or the rack may be changed if necessary. Finally, since rack 20 and anode electrode 14 and cathode electrode 16 are held in place as set forth above, the supplemental electrodes are also held in place because they are secured to rack 20 by holder rod 72. It should also be understood that although the electrodes are all being depicted generally as flat shaped electrodes, that electrodes having other shapes such as corrugated or wave shapes, but not limited to such shapes, are contemplated.

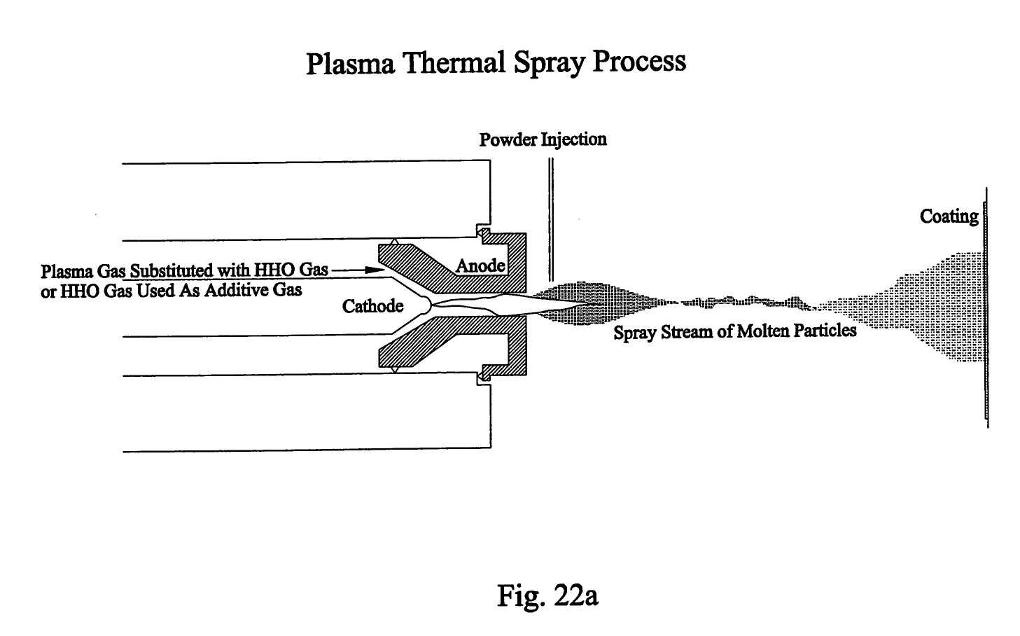

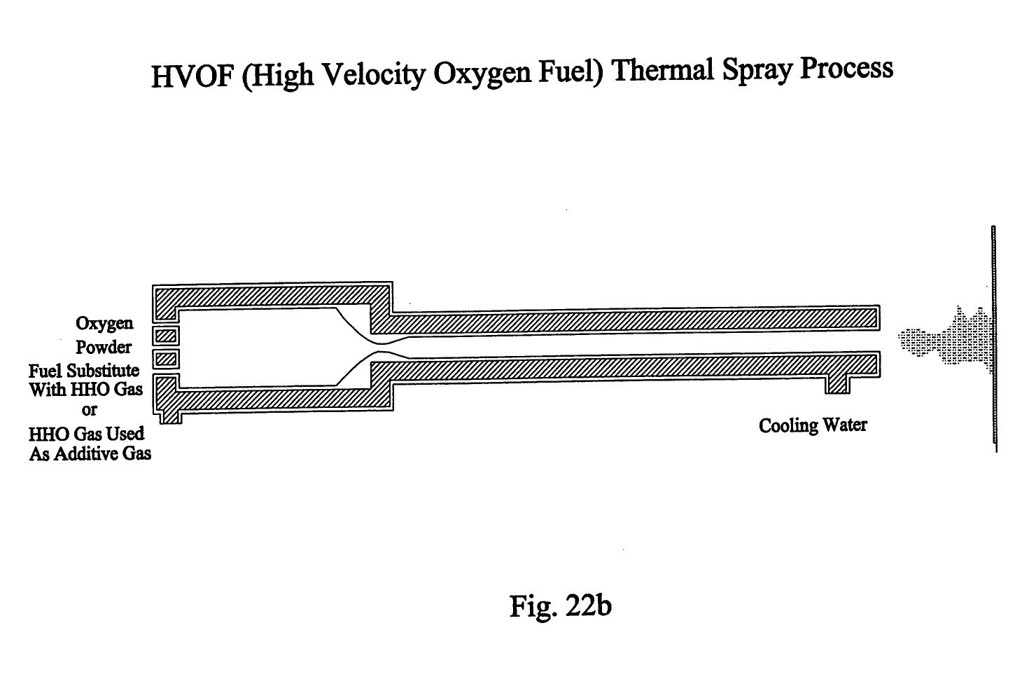

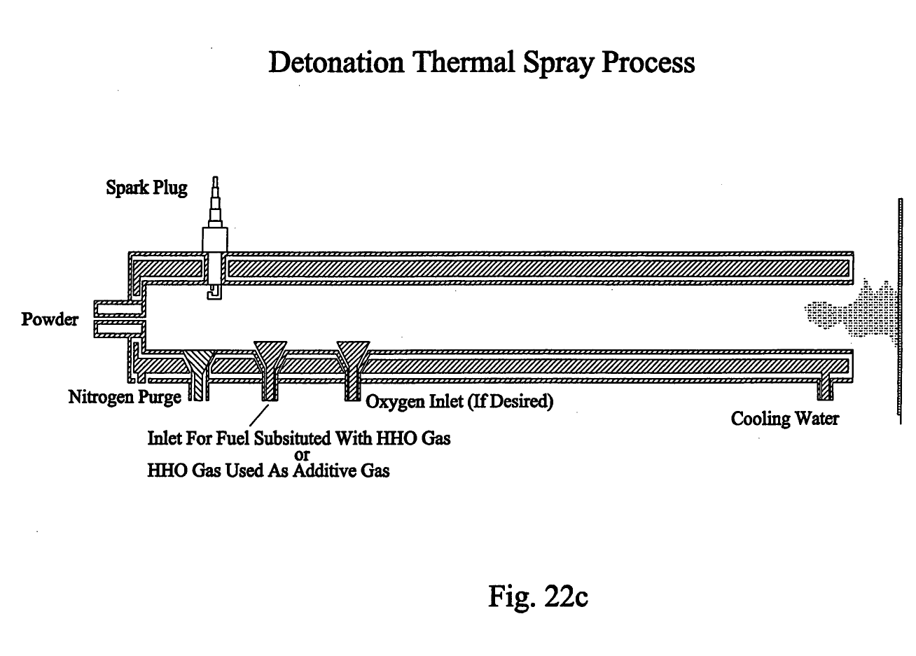

As a frame of reference, the inventive use of the HHO gas for thermal spray coating systems can be used with any of the aforementioned prior art spray processed to obtain the above-described unique and novel characteristics, and FIGS. 22a-22c are intended to be merely examples of representative processes noting the inclusion (additive or supplemental to) or total substitution of HHO gas for the fuel source typically used in such prior art processes. Other processes are not shown as it can be well understood from the description above and the representational drawings presented what the scope of the invention is. When using the process of FIG. 22c, oxygen may still be added if desired to achieve certain results.

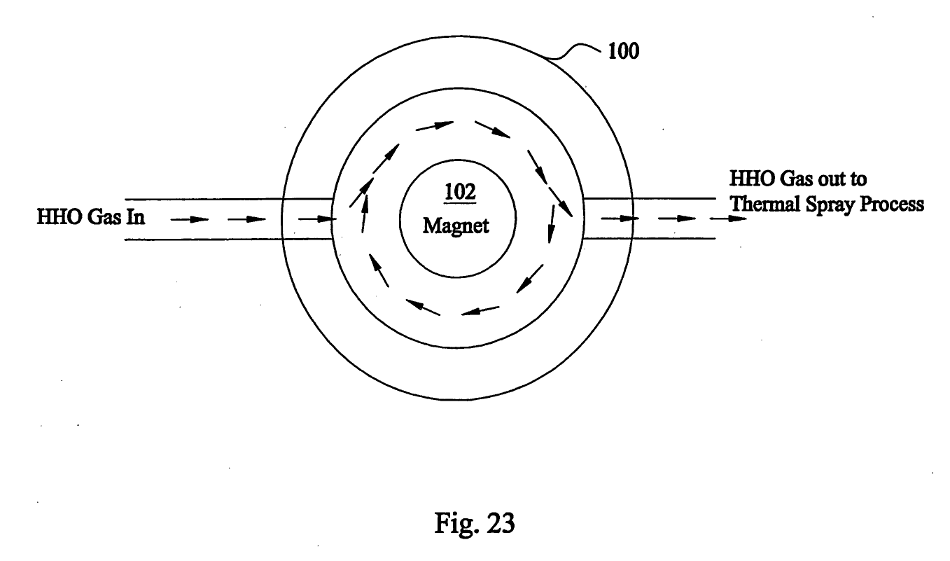

As shown in FIG. 23, the HHO gas can be optionally routed through a magnetic centrifuge product 100, such as centrifuge model no. LG-X 200, sold under the trade name “Algae-x.” Typically, this type of centrifuge has a high gause magnet 102, around which the gas is centrifuged. This additional step gives an additional magnetic bond to the gas as it ignites the powder to be sent into the thermo spray stream, causing a stronger bond to the product being sprayed and producing more adhesion thereby giving a far superior finished product.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A thermal spray coating process for depositing finely divided metallic or nonmetallic materials in a molten or semi-molten condition to form a coating on a substrate wherein the coating material may be in the form of powder, ceramic-rod, wire or molten materials, the process comprising:
using in the thermal spray coating process a gas made from water in an electrolyzer for the separation of water as a fuel and heat source, wherein said gas is used as an additive or supplemental source of said fuel and heat source to another fuel and heat source or is used as a sole source of said fuel and heat source, the electrolyzer comprising:
an aqueous electrolytic solution comprising water, the aqueous electrolyte solution partially filling an electrolysis chamber such that a gas reservoir region is formed above the aqueous electrolyte solution, said chamber being adapted to be installed in a pressurized system;
two principal electrodes comprising an anode electrode and a cathode electrode, the two principal electrodes being at least partially immersed in the aqueous electrolyte solution;
a plurality of supplemental electrodes at least partially immersed in the aqueous electrolyte solution and interposed between the two principal electrodes wherein the two principal electrodes and the supplemental electrodes are held in a fixed spatial relationship, and wherein the supplemental electrodes are not connected electrically to a power source;
for each supplemental adjacent electrodes, one is made of a high porosity latticed foam material made substantially of a nickel material and the opposing electrode is made substantially of a stainless steel material; and
said electrolyzer being adapted to separate the water such that its constituents of H and O are not recombined and instead produced jointly to make the single combustible gas composed of combinations of clusters of hydrogen and oxygen atoms structured according to a general formula HₘOₙ wherein m and n have null or positive integer values with the exception that m and n can not be 0 at the same time.

2. The process according to claim 1, wherein said high porosity latticed foam material contains greater than 99% nickel.

3. The process according to claim 1, wherein the combustible gas produced when lighted as a flame in open air burns with a flame temperature at its core in said open air of from about 255° F. to about 288° F.

4. The process according to claim 2, wherein when the flame comes into contact with a target material, said combustible gas does combine by sublimation creating a catalyzing effect with the target material being impinged by the combustible gas flame that results in a rapid melting of the target material being impinged, which temperatures are dramatically increased by the sublimation and catalyzing effects of the gas flame on the target material.

5. The process according to claim 4, wherein said temperatures vary depending on the target material being impinged by the combustible gas flame, wherein said target material is selected from refractive materials consisting of carbon steel, tungsten, bricks and ceramic materials.

6. The process according to claim 4, wherein said temperatures vary depending on a percentage of mixture of the HHO gas with the other fuel and heat source being used in the process.

7. The process according to claim 1, wherein the two principal electrodes and the one or more supplemental electrodes are separated by a distance of about 0.15 to about 0.35 inches.

8. The process according to claim 1, further comprising:
routing the gas though a magnetic centrifuge prior to introducing the gas in the thermal spray process being used.

9. The process according to claim 1, wherein the thermal spray coating process is a plasma thermal spray process.

10. The process according to claim 1, wherein the thermal spray coating process is a detonation thermal spray process.

11. The process according to claim 1, wherein the thermal spray coating process is a high velocity oxygen fuel thermal spray process.

12. The process according to claim 1, wherein the thermal spray coating process is a low velocity oxygen fuel thermal spray process.

13. The process according to claim 1, wherein the thermal spray coating process is a combustion wire thermal spray process.

14. The process according to claim 1, wherein the thermal spray coating process is a combustion powder thermal spray process.

15. The process according to claim 1, wherein the thermal spray coating process is an arc wire thermal spray process.

16. The process according to claim 1, wherein the supplemental electrodes are connected to a power source.
